(19) United States
(12) Patent Application Publication
(10) Pub. No.: US 2011/0088786 A1
(43) Pub. Date: Apr. 21, 2011

(54) METHOD FOR MANIPULATING A LIQUID ON A FABRICATED MICROSTRUCTURED PLATFORM

(75) Inventors: Gert BLANKENSTEIN, Dortmund (DE); Thomas Willms, Castrop-Rauxel (DE); Ralf-Peter Peters, Bergisch-Gladbach (DE); Claus Marquordt, Dortmund (DE); Holger Bartos, Dortmund (DE)

(73) Assignee: Boehringer Ingelheim microParts GmbH, Dortmund (DE)

(21) Appl. No.: 12/977,516

(22) Filed: Dec. 23, 2010

Related U.S. Application Data
(63) Continuation of application No. 11/101,451, filed on Apr. 8, 2005.
(60) Provisional application No. 60/560,263, filed on Apr. 8, 2004.

(51) Int. Cl. F15D 1/00

(52) U.S. Cl. 137/1; 137/624.11

(57) ABSTRACT

A method for manipulating a first liquid within a device including fabricated microstructures for transporting the first liquid through a system of capillary channels and cavities with a closed configuration. The method including transporting the first liquid through the system by capillary force only, stopping a flow of the first liquid temporarily at a capillary stop, switching on the flow of the first liquid after a desired stop time is elapsed, adjusting the stop time of the first liquid by a length and a cross-section of the control capillary between a beginning of the control capillary and its end at the capillary stop, metering the first liquid to be manipulated, and holding a metered amount of the first liquid during the stop time within a cavity.

### CROSS REFERENCE TO RELATED APPLICATION

This application is a continuation of and is based upon and claims the benefit of priority under 35 U.S.C. §120 for U.S. Ser. No. 11/101,451, filed Apr. 8, 2005, which claims the benefit of the earlier filing date of U.S. Provisional Patent Application Ser. No. 60/560,263 filed on Apr. 8, 2004, the entire contents of each of which are incorporated herein by reference.

### FIELD OF THE INVENTION

The invention relates to a microstructured platform and a method for manipulating a liquid in physical, physicochemical, chemical, biochemical, or biological analyses.

The microstructured platform contains structure elements, defined by position, shape, and size, with dimensions in the micrometer range, which have been introduced according to plan into the platform, and which clearly contrast with the roughness of the surface of the platform material.

The liquid can be analyzed, for example, by means of a microscope for optical properties and changes therein in the infrared, visible, or ultraviolet region of the spectrum. In chemical analyses, the liquid can react with other substances, as a result of which properties of the liquid are perceptibly changed. The fluorescence of the liquid, for example, can be changed in such a reaction. A fluorescent liquid can lose some or all of its fluorescence. A nonfluorescent liquid can become fluorescent. The properties of the analyzed liquid can be derived from this type and from other changes. Further, these particles can be separated from a liquid containing the particles or a portion of the liquid is separated.

The purpose of the invention is to facilitate or enable the manipulation of liquids preferably when only a very small amount of liquid in the microliter range is available and extensive analyses, which may be qualitative, semiquantitative, or quantitative, are to be performed with the liquid.

### DESCRIPTION OF THE RELATED ART

In many chemical and biochemical analyses of liquids, it is necessary to treat the provided liquid under predefined reproducible conditions. These include, for example, the metering of the sample and the control of the analysis process from time or kinetic viewpoints. It can be necessary to separate a portion of the liquid from the provided sample and then to treat further one or the other portion of the liquid. Further, a defined amount of the sample can be brought into contact with a reagent for a predefined time period.

Valves, which are controlled, for example, by means of a computer program, are used in conventional processes for metering and control processes. This requires a high expenditure for equipment. Conventional devices can be miniaturized only to a limited extent. It is difficult to perform extensive analyses in liquids, which are available in only a small amount, using the conventional devices.

It is desirable for chemical and biochemical analyses to use devices which are suitable for liquid, samples, which are available in only a small amount. The need for such devices is especially high, if specific analyses are to be performed routinely using a specified method for many samples, and if each device may only be used once a hygienic reasons. It is desirable further to be able to use devices whose structure can be adapted to different analytical tasks and which can be produced with high precision in large numbers at acceptable cost.

DE 198 10 499 discloses a microtiter plate, which is used in the microbiological analysis of liquids. This microtiter plate is an improvement of the previously employed plates. The distribution of the sample chambers is tailored to the filling and evaluation devices. The microtiter plate is closed on both sides. Groups of sample chambers are connected via inlets and connecting passages with one filling site in each case. The sample chambers have breather zones, which are linked in groups to breather passages and connected to a breather outlet. In each sample chamber, the filling volume of the liquid is self regulating, which simplifies the filling of the sample chambers with the liquid to be analyzed. The microtiter plate is suitable for various optical analytical methods.

WO 99/46045 discloses a sample support as an improvement of the microtiter plate in accordance with DE 198 10 499. The sample support comprises at least one filling chamber for the liquid to be analyzed, at least one reaction chamber with a supply channel, and at least one distribution channel, which connects a filling chamber with several supply channels. Each reaction chamber has a ventilation opening. The supply channels and the distribution channels are made as capillaries, in which the liquid is transported by capillary force. At the discharge of each supply channel into a reaction chamber, there is an area with a very small fillet radius, in which the capillary force is greater than in the supply channel. This type of area enables the liquid to flow from the supply channel to the reaction chamber. Each reaction chamber is provided with a ventilation opening to which a connection channel with capillary dimensions is joined. Several connection channels discharge into a ventilation collection channel, which has a ventilation opening. Preferably, at the end of each connection channel, where the connection channel discharges into the ventilation collection channel, the cross section of the connection channel can become abruptly larger, as a result of which flow of the liquid emerging from the reaction chamber beyond this point is prevented.

The sample support can have valves or areas with a valve function, with which the flow of the sample liquid into the reaction chambers can be controlled from the outside. A valve can consist of rupture film. A zone with valve action can be an abrupt expansion of a channel with capillary dimensions or a channel section with a hydrophobic wall. A valve or a zone with valve action can be changed from the blocked state to the pass state by application of excess pressure or low pressure. Further, a channel with capillary dimensions can discharge into each channel expansion, said channel through which the channel expansion can be filled with a control liquid, by which the zone with valve action cats be bridged.

Manipulations to be performed outside the microstructured zone are necessary to overcome a zone with valve action by means of a pressure difference.

EP 1 013 341 discloses a device for removing a liquid from capillaries, separation devices, such as filters and membranes, in which the capillary force, which retains the liquid component to be separated in the separation device, is active, are used to separate liquid components from a liquid. If there is only a small amount of liquid, it can be difficult to remove the liquid component to be separated in a free and unchanged form from the separation device.

This process step is simplified or facilitated by a wedge-shaped cutout at the exit end of the capillary or in a columnar body which is in contact with the exit end of the capillary. A radius of curvature of the wedge edge is smaller than the radius of the capillary. The base side of the wedge-shaped cutout joins a collecting chamber in which the separated liquid component is collected and in which the capillary force in less than in the capillary.

The wedge-shaped cutout exerts a suction effect on the wetting liquid present at the wedge-shaped cutout. The suction action begins and continues as soon as and as long as liquid is present at the beginning of the wedge-shaped cutout and as long as the collecting chamber is covered only on its base with a liquid layer in the vicinity of the wedge-shaped cutout. The suction action begins on its own and cannot be influenced from the outside.

This device enables the separation of liquid components in the microliter range. It can be used to separate a liquid from a solid-containing medium by means of a filter membrane, for separating blood plasma from whole blood by means of a separator membrane, or for filling a well by means out a feed capillary.

EP 1201304 discloses a microstructured platform (“microchip”) for analyzing a liquid. The microchip contains a filling region and a testing region, and optionally a collection region for the liquid that emerges from the testing region, as well as a system of capillary-shaped channels. Further, the microchip can contain one or more fluidic structures, such as a butterfly structure, a cascade structure, a forked structure, a delay structure for the leading edge flow, and a capillary force based structure by which the liquid flow stream can be stopped. Fluidic structures of this type make possible, on the one hand, the uniform spread of the liquid stream, which passes from a (narrow) capillary (capillary channel) with capillary dimensions in both directions transverse to the direction of flow into a (wide) capillary (capillary gap) with a capillary dimension in only one direction transverse to the direction of flow. During the passage to a wide capillary, the liquid thereby obtains a homogeneous flow profile required in special analyses. On the other hand, such structures make it possible to uniformly merge a liquid stream which passes from a broad capillary into a narrow capillary.

This microchip is suitable for applications and analyses of liquids containing biomolecules, such as nucleic acids and peptides.

WO 02/097398 describes a closed platform for analyzing biomolecules. The platform contains fluidic microstructures such as butterfly structures, forking structures, and delay structures. This platform can be used for analyses which were carried out previously on a slide under a microscope. The platform allows the use of instruments for manipulation and evaluation employed thus far in analyses of this type. It is used, for example, for the covalent immobilization of polypeptides and nucleic acids.

In wet-chemical, biochemical, and diagnostic analyses, metered aliquots of a liquid are to be separated from a larger amount of liquid. To that end, cavities with a defined volume are filled with an amount of liquid. Mechanical separating elements are used to separate the metered amount of liquid from the larger amount of liquid. In another method, the amount of liquid, which exceeds the defined volume of a cavity, is removed by suction, as a result of which the metered amount of liquid is obtained. Further, the amount of liquid, which exceeds the metered amount of liquid, can be “blown away” by a pressure burs Further, an amount of liquid can be metered in by drawing in or blowing in. Means to create pressure are necessary for this type of metering and separating procedure.

It can be necessary with a platform for manipulating a liquid to apply a limited amount of liquid in the microliter range to a predefined site on a smooth surface of a solid body and to hold it together at the predefined site. The spreading of the liquid is to be prevented. This requirement can be satisfied if the wettability of the surface of the body at the predefined site is greater than the area, located at the same height, surrounding this site. Either the wettability of the predefined site can be increased or the wettability of the area surrounding the predefined site can be reduced. To that end, the surface of the body can be coated, for example, in areas using prior-art methods, or it can be provided with a different roughness in areas. In both methods, additional process steps are required in the production of the platform. It can be desirable further to make the amount of liquid to be held together at this site greater than the amount that can be held together on an area more hydrophilic relative to the surrounding area.

### SUMMARY OF THE INVENTION

The object thereby is to develop further prior-art microstructured platforms and to provide a platform and a method for manipulating a wetting liquid, which is optionally present only in an amount in the microliter range. The walls of the microstructures are at least wettable by the liquid in areas touched by the liquid. Only minor expenditures for equipment should be necessary during the manipulation. The liquid should be manipulated simply, reliably, and reproducibly. The platform is to be adaptable to different analyses, also to multi-step analyses, which comprise several sequential process steps. A plurality of process steps should be able to proceed one after another and a plurality of chains of such process steps should be able to proceed on a platform in a plurality of paths side by side and approximately simultaneously, to wit, in both cases largely without outside intervention. Further, chains of process steps with different configurations on a platform should be able to run side by side and possibly simultaneously. The platform is to be suitable for single use and is to be producible economically in large numbers.

This object is achieved according to the invention by means of a microstructured platform for manipulating a wetting liquid, which on a microstructured support

comprises cavities and a channel system for transporting the liquid, which is provided with at least one inlet and with at least one outlet, and the cross section of the channels in sections differs in size and shape, and

the channels are made as capillaries, which have a dimension in the millimeter range and less, preferably 5 millimeters to 4.5 micrometers, in at least one direction transverse to the transport direction of the liquid at least in sections, and

the walls of the microstructures are wettable at least in areas, whereby the platform

comprises at least one other microstructured element, which is disposed in the transport path of the liquid, from the group of the microstructured elements

fluidic switch with a capillary stop for stopping and setting a liquid stream in motion in the capillary at the transition from a narrower capillary to a widened capillary, and with a control capillary, which is joined to the capillary stop,

metering means for the liquid to be manipulated with a capillary stop and with a substantially T-shaped junction, at which the liquid feed stalls, and with a space, which takes up the metered amount of liquid, and is disposed the between capillary stop and the junction,

separating device for a liquid substream from a dispersion with a capillary gap, which is joined laterally to a channel, through which the dispersion flows,

region for holding together a limited amount of liquid, which contains microstructures, which stand substantially perpendicular on the bottom of the area, and between which there are interspaces with dimensions between the microstructures—parallel to the bottom of the area—which are in the micrometer range.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings, wherein:

FIG. 1 is a schematic view of the microstructured platform according to one embodiment of the present invention;

FIGS. 2a is a schematic view of the microstructured platform including two reaction chambers, a plurality of fluidic switches, and a washing device according to one embodiment of the present invention;

FIG. 2b is a schematic view of the microstructured platform including two reaction chambers, a plurality of fluidic switches, and a washing device according to one embodiment of the present invention;

FIG. 3 is a schematic view of the microstructured platform including a metering device, two fluidic switches, and three reaction chambers in two analysis branches according to one embodiment of the present invention;

FIG. 4 is a schematic view of the microstructured platform including a capillary gap and a metering device according to one embodiment of the present invention;

FIG. 5 is a schematic view of the microstructured platform including a plurality of cavities, washing device, and a plurality of fluidic switches according to one embodiment of the invention;

FIG. 6 is a schematic view of the microstructured platform including a plurality of cavities and a plurality of metering branches for the liquid to be manipulated according to one embodiment of the invention;

FIG. 7 is an oblique view of a capillary, capillary jump, and a widened capillary according to one embodiment of the invention;

FIG. 8a is an oblique view of a narrower capillary, a widened capillary, control capillary according to one embodiment of the present invention;

FIG. 8b is an enlarged oblique view of the control capillary and wedge-shaped cutout depicted in FIG. 8a;

FIG. 9a is an oblique view of a narrower capillary, capillary jump, control capillary, and wedge-shaped cutout according to one embodiment of the invention;

FIG. 9b is an enlarged oblique view of the control capillary and wedge-shaped cutout depicted in FIG. 9a;

FIG. 10 is an oblique view of a section of the platform including a narrower capillary, capillary jump, widened capillary, and control capillary according to one embodiment of the invention;

FIG. 11 is an oblique view illustration a stair construction for the end region of the control capillary according to one embodiment of the invention;

FIG. 12 is an oblique view illustration the end portion of the control capillary being in the form of a ramp according to one embodiment of the invention;

FIG. 13 is an oblique view of another embodiment of the control capillary according to one embodiment of the present invention;

FIGS. 14a and 14b are a top and cross sectional views, respectively, of a platform provided with microstructures in areas according to one embodiment of the invention;

FIGS. 15a and 15b are a top and cross sectional views, respectively, of a platform provided with microstructures in areas according to one embodiment of the invention; and

FIGS. 16a and 16b are a top and cross sectional views, respectively, of a platform provided with microstructures in areas according to one embodiment of the invention.

and 2b are schematic view of the microstructured platform according one embodiment of the present invention;

### DETAILED DESCRIPTION OF THE PREFERRED EMBODIMENTS

Referring now to the drawings, wherein like reference numerals designate identical or corresponding parts throughout the several views.

The platform of the invention for manipulating a liquid with microstructured elements, which are disposed in the transport path of the liquid, contains a system of channels as longitudinal cavities and other cavities in a solid body.

The dimensions of the channels in at least one direction transverse to the transport direction of the liquid are in the millimeter range and less. The “capillary dimensions” transverse to the transport direction of the liquid constitute, for example, 10 micrometers to 1000 micrometers, preferably 50 micrometers to 400 micrometers. The length of the channels can constitute several centimeters, for example, 2 millimeters to 50 millimeters, preferably 5 millimeters to 10 millimeters. Channels of this type are called capillaries in the following text.

The volume of the other cavities constitutes, for example, 1 microliter to 1000 microliters, preferably 2 microliters to 200 microliters, and for microanalyses 2 microliters to 50 microliters. The dimensions of the capillaries in two (perpendicular to one another) directions transverse to the transport path of the liquid can be equal in size. Such capillaries are tubular.

Capillaries, which have a “capillary dimension” in a direction transverse to the transport direction of the liquid, and which have a dimension greater than the “capillary dimension” in a different direction transverse to the transport direction of the liquid, are called capillary gaps.

A capillary can be straight in the lengthwise direction or bent largely as desired. The capillary can be virtually as long as desired. The capillary cross section can be shaped largely as desired.

A tubular capillary can have a circular cross section or a round, cross section with virtually away other shape (for example, an elliptical cross section). Further, the cross section can have the shape of any regular or irregular polygon. The cross section can be rectangular or square; in a rectangular cross section, the side lengths of the rectangle are of the same magnitude. Triangular cross sections in the shape of an equilateral triangle or any triangle are also possible. Further, the edge of the cross section of a capillary can be straight in areas and curved in areas, whereby the curving can be convex or concave.

In non-round cross sections, the edges in the capillary can have a curvature, which can vary or be selected over a wide range.

The platform of the invention can be open (not covered); i.e., all capillaries and cavities are open at the top. In the preferred embodiment, the platform is covered at least in areas.

A liquid in a capillary is subject substantially to the capillary force and surface tension, which determine the behavior of the liquid within the capillary. A wetting liquid is transported within the capillaries by capillary force.

A capillary can have a capillary jump, at which the cross section of the capillary changes abruptly along its entire circumference or along most of its circumference. On one side of the capillary jump, there is a relatively narrower capillary and on the other side, a relatively widened capillary.

If the widened capillary is located downstream of the narrower capillary and the liquid in the narrower capillary flows against the capillary jump, the liquid in the narrower capillary is stopped at the capillary jump. The capillary jump acts as a capillary stop in this direction of flow.

If the narrower capillary is downstream of the widened capillary and if a liquid in the widened capillary flows against the capillary jump, the liquid in the widened capillary is not stopped at the capillary jump. The capillary jump does not act as a capillary stop in this direction of flow.

It is the most advantageous if the narrower capillary at the capillary jump transitions into the widened capillary along its entire circumference. If this requirement can only be realized with expense, it is sufficient according to the invention if the narrower capillary transitions into the widened capillary along most of its circumference. Capillaries with square cross sections can be present, for example, as grooves in a plate. At the capillary jump, the narrower capillary transitions into the widened capillary, which is deeper and wider than the narrower capillary. In this case, the capillary jump extends over three-fourths of the circumference of the narrower capillary.

In its first embodiment, the platform of the invention can comprise at least one metering means for the least one aliquot of the liquid to be manipulated and for the separation of the aliquot from a larger amount of liquid, as well as at least one fluidic switch. It can comprise further a fast cavity as an inlet for the liquid to be manipulated and a second cavity as an outlet. The outlet is connected with the inlet by a first capillary. The capillary force at the outlet of the first capillary can be the same or greater than the capillary force at the inlet of the first capillary. At least one second capillary branches off from the first capillary, the second capillary whose dimension in at least one direction transverse to the transport direction of the liquid in the second capillary at least at the branching point is smaller than the smallest dimension of the first capillary transverse to the transport direction of the liquid in the first capillary. At the branching point, the geometric properties change abruptly at the transition from the first to one of the second capillaries. The capillary force at the inlet into the at least one second capillary is greater than the capillary force in the first capillary in the area of the branching point. The predefined volume of each second capillary can be the same or different in size for all second capillaries. The branching point of the second capillary from the first capillary is substantially T-shaped. The second capillary branches off approximately perpendicularly from a substantially straight segment of the first capillary.

The second capillary contains a capillary jump, at which it transitions along its entire circumference or along most of its circumference abruptly into a “widened capillary.” The second capillary is called a “narrower capillary” upstream of the capillary jump. This capillary jump functions as a geometric capillary stop for the liquid in the narrower capillary. The cross-sectional area of the widened capillary is at least 10% greater than the cross-sectional area of the narrower capillary. A larger capillary jump is required for liquids with a relatively low surface tension.

A control capillary, through which a control liquid is taken to the capillary stop, discharges into the widened capillary. The control capillary at its end without the capillary stop can transition along most of its circumference into the widened capillary, If there is a capillary jump at the cod of the control capillary, a wedge-shaped cutout is made in the wall of the capillary jump, said cutout which can extend from the bottom of the control capillary to the bottom of the widened capillary. In both embodiments, the liquid flows out of the control capillary without delay into the widened capillary and fills the widened capillary in the area of the capillary jump. As soon as the liquid from the control capillary comes into contact with the liquid stopped in the second (narrower) capillary at the capillary stop, the fluidic switch is opened and the liquid in the second (narrower) capillary is transported further in the widened capillary.

The control capillary can branch off the second capillary at a suitable place. Further, it can be joined to a cavity filled with a liquid on the platform. On the platform with many structure elements, the control capillary can be joined to another capillary or to a site (cavity or capillary). The start of the control capillary can be located at a distance—over several structure elements—from its end, where it is joined to the widened capillary, which belongs to the fluidic switch, which is to be opened by the liquid in the control capillary.

The control capillary together with the geometric capillary stop fortes a fluidic switch.

The capillary force at the start of the control capillary is greater than the capillary force in the second capillary in the area of the branching.

The control capillary can be meander-shaped and can contain a widened area. The stop time of the liquid in the second capillary begins with the stopping of the liquid at the capillary stop and ends at the time when the control liquid, which has entered the widened capillary, comes into contact with the liquid stopped at the capillary stop. The stop time is substantially the time required by the control liquid to flow from the entrance to the control capillary to the widened capillary. In a control capillary, which is connected to the second, capillary before the capillary stop, the stop time is substantially determined by the length of the control capillary. The length of the control capillary, for example, in a meander-shaped control capillary, can, be selected over a wide range. The liquid volume, which is present in the control capillary, constitutes a few percentages of the liquid volume that flows over the fluidic switch controlled and opened by the control capillary.

The control capillary can have a cross section of virtually any desired shape. A rectangular or a square cross section is preferred. The side length of the square constitutes from 10 micrometers to 400 micrometers, preferably from 50 micrometers to 200 micrometers. The control capillary can be from 5 millimeters to 400 millimeters in length. Stop times of 0.5 seconds to 20 minutes can be achieved with a control capillary with a square cross section with a 50-micrometer side length (with water as the control liquid). If the control capillary has a widened area, thus, a section with a larger cross section and greater volume, stop times can be achieved that are greater than the stop times achievable with a control capillary without a widened area.

The control capillary can be connected to a third cavity on the platform. The third cavity-independent of the filling of the liquid to be manipulated into the inlet of the first capillary—cats be filled with a control liquid. The time between the filling of the liquid to be manipulated into the inlet of the first capillary of the platform and the filling of the control liquid into the third cavity of the platform can be freely selected over a wide .range.

The widened capillary can discharge into a fourth cavity, which, is configured as a reaction chamber. The transition of the widened capillary to the fourth cavity is made without a capillary stop. The fourth cavity, on the one hand, can be connected with the environment via a last capillary, which is open at its end. On the other hand, the fourth cavity can be connected via a third capillary with a collection space with the separated aliquot of the liquid. The transition from the third capillary to the collection space is made without a capillary stop.

For multi-step reactions, a plurality of cavities can be arranged one after another, which are connected by capillaries—with or without a fluidic switch. In this case, the last cavity can be connected with the environment via a last capillary, which is open at its end.

The last capillary in each case is used for ventilation, as soon as the liquid to be manipulated enters the associated second capillary at the branching point.

The metered aliquot of the liquid is determined by the volume of the second capillary between its branching point from the first capillary and the capillary jump. This volume can be adjusted to the desired volume of the aliquot via the length of the second capillary and/or a widened area or a cavity in the course of the second capillary. The widened area or cavity in the course of the second capillary can be configured as a reaction chamber.

The reaction chamber, into which the widened capillary discharges, contains preferably dried—reagent, which can cause a reaction in the metered aliquot of the liquid. In just the same way, the widened area or the cavity in the course of the second capillary can contain a preferably dried—reagent, which can cause a reaction in the liquid on its own or in conjunction with the reagent in the reaction camber following the widened capillary.

The reaction of the liquid with the reagent in the cavity in the course of the second capillary and/or the reaction of the liquid with the reagent in the .reaction chamber, into which the widened capillary discharges, can cause a change in the liquid. This type of change can be observed—preferably optically—in the widened area in the course of the second capillary and/or in the reaction chamber. During the observation, the widened area in the second capillary and/or the reaction chamber can still contain or not contain the liquid to be manipulated. This type of change or absence of a change can indicate the presence or absence of a component in the aliquot, to be manipulated, of the liquid.

The microstructured chain of elements comprises in the first embodiment of the platform a second capillary-with or without a widened area-and a fluidic switch and at least one cavity. One or more cavities can be used for reactions and can contain reagents. At least one of the cavities in the chain is used as an analysis chamber, in which a change that has or has not occurred can be detected visually qualitatively or semiquantitatively or determined quantitatively by photometry. Multiples of this chain of elements-alone or together with other elements—can be present in the platform.

The liquid is manipulated as follows in the platform in its first embodiment. A limited amount of the liquid to be manipulated, from which at least one metered aliquot is to be removed, is filled into the inlet before the first capillary. The limited fill volume is somewhat greater than the predefined total volume of all second capillaries of the platform between their inlet and the associated capillary stop plus the volume of the first capillary between its inlet and outlet.

The filled liquid enters the fast capillary by capillary force and flows in the direction toward the outlet of the first capillary. As soon as the liquid flows past the branching point of the second capillary, because of the relatively greater capillary force, it enters the second capillary at its entrance and fills the second capillary up to the associated capillary stop, by which it is initially stopped. The gas, for example, air, present in all capillaries at ambient pressure, is first displaced by the incoming liquid and escapes from the outlet of the first capillary and beyond the capillary stop in each second capillary out of the outlet assigned to each second capillary. The capillary stop stops a flowing liquid but not a flowing gas. All second capillaries are filled with liquid from the first capillary in precisely the same way.

The provided liquid flows into the inlet of the first capillary at least until all second capillaries are completely filled with liquid up to the respective capillary stop. After the last second capillary is filled with liquid, the liquid introduced into the inlet is substantially present in the second capillaries. Due to the greater capillary force at the end of the first capillary than at its beginning, the rest of the liquid provided at the inlet flows into the outlet. The first capillary-beginning at its inlet becomes empty and fills with the ambient gas, for example, with air. When the end of the liquid in the first capillary passes the branching point of a second capillary, the metered aliquot contained in the second capillary is separated from the rest of the liquid in the first capillary. The liquid in the second capillary does not flow back into the first capillary. As soon as the first capillary is free of liquid along its entire length, the aliquots in all second capillaries are separated from the rest of the liquid and from each other. The partial volumes in the second capillaries between their inlet and the associated capillary stop can differ in size, This can be achieved by an expansion over the course of the second capillary.

The capillary stop at the end of each second capillary stops the flow of the liquid until the control liquid has sufficiently filled the beginning of the widened capillary behind the capillary stop, and the control liquid comes into contact with the liquid present at the capillary stop. This again sets into motion the flow of the liquid in the second capillary. The metered and separated partial volume, contained in each second capillary, of the liquid to be manipulated flows over the capillary stop and is transported further by capillary force into each downstream cavity, where it is available for further use. The stop time can be the same for all second capillaries, or they can be different in size.

The stop time of a fluidic switch is the time which passes between the entry of the control liquid into the control capillary and the filling of the control capillary with control liquid up to its end in the area of the capillary jump in the second capillary. The stop time can constitute 0.1 seconds to 20 hours. It is determined by the time predefined for the course of a reaction in the liquid to be manipulated.

If the control capillary is joined to the second capillary, or if the control capillary is joined to another cavity on the platform and this cavity is filled with another amount of liquid to be manipulated, the control liquid is the same as the liquid to be manipulated. If the other cavity on the platform is filled with another liquid, the control liquid is different from the liquid to be manipulated.

The platform of the invention can contain, in addition to the aforementioned elements, outer fluidic switches and other cavities, which can be arranged behind or parallel to the aforementioned elements. Such arrangements can contain a plurality of reaction chambers and be used for multi-step reactions, for which several stop times of different length can be predefined.

The platform of the invention in its first embodiment can be used for the following process steps without outside intervention:

to remove predefined aliquots of the liquid to be manipulated separately from each other and to separate them from the liquid to be manipulated,

to bring the metered aliquots in each case into contact with a predefined amount of reagent, whereby the reagent can be immobilized or dissolved or resuspended by the liquid, and another reagent can be selected for each metered aliquot,

to stop metered aliquots, which are separated from the liquid to be manipulated, for a predefined stop time, whereby the stop time can be selected as different for each aliquot over a wide range,

to transport further metered aliquots after the elapse of the specific stop time by opening of the fluidic switch,

to bring metered aliquots in contact with a second and, if necessary, with other reagents,

to detect changes in each metered aliquot separately from one another after reaction with at least one reagent preferably optically, for example, as a change in color, extinction, fluorescence, turbidity, birefringence, or an other preferred optical feature, whereby the observed intensity of the feature can appear or disappear.

For example, a conclusion can be reached in medical diagnosis about the presence or absence of a substance suspected of being present in the liquid to be manipulated.

The process steps can be carried out quantitatively or semiquantitatively. Several chains of the mentioned process steps can proceed with the same or different selected parameters in parallel within a platform with the same liquid to be manipulated.

Because of the design of the platform, preferably, several metered aliquots of the liquid to be manipulated are provided, which tape up the predefined amounts of the employed to reagents in each case. The changes occurring in each aliquot of the liquid to be manipulated are analyzed in a defined and reproducible form.

In a second embodiment, the platform of the invention, for example, according to the first embodiment, can contain in addition at least one region provided with microstructures, which is used to hold together a limited amount of liquid on the surface of the microstructured platform where the limited amount of liquid is applied.

The microstructured region for holding together a limited amount of liquid can contain structure elements in the form, of columns or crosspieces, which are substantially perpendicular to the bottom of the microstructured region and the dimensions thereof in at least one direction parallel to the bottom are in the micrometer range from 0.1 μm to 500 μm. The columns or crosspieces can be several millimeters high. The cross section of the columns or crosspieces can be shaped largely as desired; it can be circular, elliptical, triangular, rectangular, regularly or irregularly polygonal, irregularly convex, irregularly concave, or can contain wedge-shaped notches at the columns or crosspieces, whereby the wedge edges run perpendicular or substantially perpendicular to the bottom of the microstructured region. The crosspieces can have virtually any shape in their direction parallel to the bottom; they can be straight, bent, or curved. Between the columns or crosspieces, there are capillary cavities whose dimensions in at least one direction parallel to the bottom are in the micrometer range of 0.1 μm to 1000 μm. The capillary cavities preferably form a continuous area.

The structure elements can further have the shape of grooves, whose dimensions in at least one direction transverse to it lengthwise direction can be in the micrometer range of 0.1 μm to 1000 μm. The grooves can be several millimeters deep. The grooves preferably form a continuous region. The grooves can have virtually any desired shape in the lengthwise direction; they can be straight, bent, meander-shaped, angled, or spiral. The cross section of the grooves can largely have any shape; it can be triangular, rectangular, or semicircular.

Several of the indicated structure elements can be present next to one another within this type of microstructured region for holding a limited amount of liquid together. Within a platform, a plurality of microstructured regions can be present for bolding a limited amount of liquid together and be provided with different structure elements.

The bottom of the region, which is provided with columns or crosspieces for holding a limited amount of liquid together, on the one hand, can be at the same level as the bottom outside this region. On the other hated, the bottom of the region provided with columns or crosspieces can be located at a lower level than the bottom, outside this region. This deeper lying region is surrounded by a wall. If the platform is approximately horizontal, a limited amount of liquid can be filled into the deeper lying region, said the liquid which is held together within this region even if the deeper lying region is not provided with columns or crosspieces. If this platform is tilted horizontally or turned upside down, the limited amount of liquid can leave the deeper lying region. If the deeper lying region is provided with columns or crosspieces, the limited amount of liquid, filled into this region, is held together and retained in the region by capillary force between the columns or crosspieces also when the platform is tilted.

The limited amount of liquid can also be dropped on or applied to this type of microstructured and uncovered region by means of a suitable device, for example, a pipette. If the microstructured region is covered, the limited amount of liquid to be applied to this region. can be selectively introduced into this region through a separate filling opening and a capillary, which connects the separate filling opening with the microstructured region.

The limited amount of liquid, which is to be held together on the surface of a solid at a predefined site, can be a solution or a dispersion of a substance, which is to be present at the predefined site and only at this site. The dissolved or dispersed substance can be a reagent, which causes a change in the liquid to be manipulated. If the liquid to be manipulated is filled into the filling opening of the platform much later than the dissolved or dispersed substance is applied to the predefined site, the dissolved or dispersed substance can be initially dried at the predefined site. The dried substance is taken up later liquid to be manipulated flowing through the transport path.

With the use of several predefined microstructured regions for holding a limited amount of liquid together on a platform, different substances can be kept ready on the platform, which cannot be influenced as long as they are kept separate in solution or in dispersion or in a dried state on the platform in adjacent regions.

The limited amount of liquid applied to this type of microstructured region is held together by the capillary force between the microstructures, which is greater in the microstructured region than in its surrounding area. The applied limited amount of liquid is held together independent of the spatial position of the platform. The platform can be tilted horizontally or it can be turned upside down, or it can be moved jerkily. The limited amount of liquid applied to the microstructured region is held together in itself and also held as a whole in the microstructured region and prevented from moving on the platform. The region provided with, microstructures can hold together a limited amount of a liquid, which is considerably greater than the amount of liquid which can be held together in the region (by the surface tension of the liquid) if the region contains no microstructures.

In the second embodiment of the platform of the invention, the liquid to be manipulated is brought into contact with the liquid that is present in the regions for holding together a limited amount of liquid. If several regions are present on the platform for holding together a limited amount of liquid, the liquid to be manipulated is brought into contact with the limited amounts of liquid, if necessary, different in volume, in the predefined sequence.

The second embodiment of the platform of the invention can be used, if at at least one predefined site of the platform a limited amount of liquid, which is applied from the outside, is to be held together. The amount of liquid usually contains a dissolved or suspended reagent. The limited amount of liquid can remain in liquid form, or the liquid components of the limited amount of liquid can be evaporated or vaporized, whereby the reagent dries.

Several limited amounts of liquid can be applied from the outside to predefined sites in a narrow space with this type of platform of the invention. The limited amounts of liquid are held together and separate from each other at predefined sites in every position of the platform, as well as during jerky movements of the platform. The liquid to be manipulated comes into contact with the limited amounts of liquid applied to the predefined sites in a predefined sequence. The contact time can be set by means of the stop time by assigned fluidic switches.

A third embodiment the platform of the invention can have, in addition to the microstructured elements of the first embodiment, a second filling site for a liquid, The second filling site is connected via a separate capillary with one of the other cavities; the other cavity, for example, can be a reaction chamber or it can be the chamber in which the optical change of the liquid to be manipulated is observed. The separate capillary, which connects the second filling site with one of the other cavities, can be provided with a fluidic switch, which comprises a geometric capillary stop and a control capillary.

In the third embodiment, a cavity, which is connected via a separate capillary with the second filling site, is filled with a liquid—with or without a reagent present therein—, before or after the liquid to be manipulated enters or has entered the cavity. If required, the liquid to be manipulated can be displaced from this cavity by the liquid from the second filling site.

Further, the second filling site can be filled with a liquid before the platform is covered. In this case, the second filling site serves as a reservoir for the second liquid.

The third embodiment of the platform of the invention can be used, for example, to load the cavity, which is connected via the separate capillary with the second filling site, with a second liquid. This process step can be called a “washing step.” It can be necessary, for example, if in a reaction in the liquid to be manipulated an excess remainder of a reagent is to be removed from a reaction chamber, if this remainder hampers or prevents the observation of a change in the liquid to be manipulated, or if this remainder interferes with the following reactions.

In a fourth embodiment, the platform of the invention can contain at least one capillary gap for separating a liquid from a dispersion. The platform can comprise further a first cavity as an inlet for the liquid to be manipulated and a second cavity as an outlet. The outlet is connected with the inlet by a first capillary. The capillary force at the outlet of the first capillary can be the same as or higher than the capillary force at the inlet of the first capillary.

At least one capillary gap branches off from the first capillary, said gap whose dimension in the first direction transverse to the transport direction of the liquid in the capillary gap is smaller at least an the branching point than the smallest dimension of the first capillary transverse to the transport direction of the liquid in the first capillary. The dimension of the capillary gap in the second direction transverse to the transport direction of the liquid in the capillary gap can be much greater than the dimension of the capillary gap in the first direction.

The platform can comprise further a third cavity, which is connected via a second capillary with the capillary gap, to wit, preferably with the edge of the capillary gap, which is opposite to the inlet edge of the capillary gap. A third capillary, whose free end is open to the environment and is made as a capillary stop, can be joined to the third cavity.

Not made as a capillary stop are

the transition from the first capillary to the exit-cavity and

the transition from the capillary gap to the second capillary and

the transition from the third capillary to the third cavity.

The open end of the third capillary is used for ventilating the upstream cavities and capillaries, as soon as the liquid to be manipulated enters in the capillary gap.

For multi-step reactions, the third cavity can be connected with one or further cavities by other capillaries.

The height of the capillary gap can constitute down to 0.1 μm, for example, in a platform made of metal. In the case of plastics, the capillary gap can be 1 μm or more in height. The height can be determined by the dimensions of the smallest particles, dispersed in the liquid to be manipulated. The width of the capillary gap is largely as desired. The throughput of the liquid flowing through the capillary gap increases with increasing width of the capillary gap.

The capillary gap can contain—preferably columnar—microstructures, as a result of which several passages form in the capillary gap. These microstructures are preferably as high as the capillary gap. The microstructures can support the cover on the platform in the area of the capillary gap.

The platform is preferably totally covered, whereby the inlet for the liquid to be manipulated is provided with an opening—for example, by piercing with a syringe—before or during filling of the liquid to be manipulated. The opening is used to fill the liquid and for ventilating the inlet cavity. The outlet—before or while the liquid to be manipulated is filled into the inlet—is provided with a ventilation opening.

The first cavity as an inlet for the liquid to be manipulated and/or the third cavity—and/or one or more of the additional cavities, which follow the third cavity—can contain dried reagents. Reactions occur in the cavities, coated with reagents, with the liquid to be manipulated or with the liquid separated therefrom by the capillary gap. At least one of these cavities functions as an analysis chamber, in which the result of such reactions can be analyzed—preferably optically. The platform of the invention in the fourth embodiment can contain several capillary gaps—optionally with different dimensions—which branch off from the first capillary.

Further, the third cavity can join the capillary gap directly. In this case, no second capillary is present between the capillary gap and the cavity. The capillary gap can transition, for example, gradually or in steps into the cavity. There is no capillary stop at this type of transition.

The total volume of a capillary gap, one or more cavities connected to the capillary, and the capillaries in between is predetermined by the microstructure of the platform. If several, capillary gaps branch off from a first capillary, the total volume for each branch can be different in size. A metered aliquot of the liquid to be manipulated, which can be analyzed semiquantitatively or quantitatively, is present in this type of total volume.

The liquid which contains dispersed particles—can be manipulated as follows in the platform in the fourth embodiment. The liquid to be manipulated is introduced in a limited amount or as a continuous stream into the inlet ahead of the first capillary. The liquid to be manipulated flows by means of capillary force through the first capillary to the exit-cavity, where it can be collected. A substream, which optionally no longer contains dispersed particles at all, or which can contain only particles below a predefined size, branches off from the liquid stream in the first capillary into the at least one capillary gap. Analyses can be performed with the substream, separated from the provided liquid to be manipulated and optionally free of dispersed particles.

During the separation of a substream from the liquid to be manipulated, the liquid, which contains all—or at least most—dispersed particles, flows past the at least one capillary gap and transports all dispersed particles to the outlet. No dispersed particles, which could block the capillary gap, collect before the inlet in the at least one capillary gap. The liquid collected in the outlet is enriched with dispersed particles.

By means of the fourth embodiment of the platform of the invention, the aliquot of the liquid, separated by means of the capillary gap and containing no or virtually no particles, is collected in the third cavity. At the same time, an aliquot, enriched with particles, of the liquid to be manipulated is collected in a second cavity.

Both aliquots can be analyzed for characteristic features—with or without interposed single step or multi-step reactions. The aliquot of the liquid separated by means of the capillary gap can be analyzed for features of the liquid. If the separated aliquot of liquid is depleted of particles, the features of the still present particles in this liquid can be analyzed, which are poorly or not at all accessible in the liquid to be manipulated, in which the dispersed particles are present in high concentration. The dispersed particles, despite the separation of a substream—depleted of particles or particle-free-are maintained in unchanged form in the environment, which is present in the liquid to be manipulated. The dispersed particles agglomerate or agglutinate only if, for example, an auxiliary agent is added which effects the agglutination of the dispersed particles.

The liquid at the outlet can be analyzed for the particles enriched therein. If the liquid to be manipulated is metered into the inlet during filling, the liquid collected at the outlet can be analyzed semiquantitatively or quantitatively.

In a fifth embodiment, the platform; of the invention can comprise at least one inlet for a first liquid, for example, for a sample liquid, a second inlet for a second liquid, for example, a washing liquid, a common outlet for the liquids, and three fluidic switches. These microstructured elements are connected by several capillaries.

The first inlet for the first liquid is connected via a first capillary with a first cavity. The first cavity is connected via a second capillary with, a second cavity. A first fluidic switched is located in the second capillary. The first control capillary branches off from the second capillary downstream of the first cavity and leads to the capillary stop of the first fluidic switch.

The second cavity is connected via a third capillary with the outlet for the liquid. The third capillary contains a second fluidic switch.

A second control capillary, which leads to a capillary stop of a third fluidic switch, branches off from the third capillary downstream of the second cavity. The second inlet for a second liquid is joined to the capillary stop of the third fluidic switch via a fourth capillary. The widened capillary of the third fluidic switch is connected via a connecting capillary with the second capillary between the first fluidic switch and the second cavity. The widened capillary of the third fluidic switch before its entry into the second capillary transitions into a narrower capillary at a capillary jump.

A third control capillary branches off from the widened capillary of the third fluidic switch and leads to a capillary stop of the second fluidic switch, which is located in the third capillary downstream of the second cavity.

If the platform is covered, the outlet and thereby the microstructure as a whole is connected with the environment via a last capillary and is ventilated via the last capillary. The last capillary at its open end can have a capillary jump, which acts as a capillary stop for the liquid present in the last capillary.

This microstructure as a whole can be present multiply on the platform of the invention. Each of these microstructures can be provided with a single first liquid from a single inlet, or with different first liquids from a plurality of inlets. The same second liquid can be used for each of these microstructures, or different second liquids can be used.

The liquids can be manipulated as follows in the platform in the fifth embodiment. A limited amount of a first liquid is introduced into the first inlet. The liquid to be manipulated flows by means of capillary force through the first capillary to the first cavity, fills this cavity, and flows through the second capillary up to first fluidic switch in the second capillary. The flow of the first liquid is stopped at the capillary stop of the first fluidic switch for the time interval set as the residence time for the first liquid in the first cavity. As soon as the first liquid passes the junction of the first control capillary with the second capillary, the first liquid enters the first control capillary. The time Interval needed by the first liquid to flow through the first control capillary up to capillary stop of the first fluidic switch is adjusted to the time interval during which the first liquid is to stay in the first cavity. The first fluidic switch is opened with the entry of the first liquid from the control capillary into the widened capillary of the first fluidic switch.

The first liquid flows through the widened capillary downstream of the first fluidic switch to the second cavity, tills this cavity, and flows through the third capillary up to the capillary stop of the second fluidic switch, which is located in the third capillary downstream of the second cavity. The flow of the first liquid is stopped at the capillary stop of the second fluidic switch for the time interval set as the residence time of the first liquid in the second cavity.

As soon as the first liquid passes the junction of the connecting capillary with the second capillary, the first liquid enters the connecting capillary and flows in this connecting capillary up to the capillary stop in the connecting capillary, which is located before the third fluidic switch. There, the first liquid is stopped in the connecting capillary.

The first liquid, which flows through the third capillary, passes the junction of the second control capillary with the third capillary and enters the second control capillary. The control liquid in the second control capillary reaches the capillary stop of the third fluidic switch and opens this switch. The third fluidic switch can already be opened before the residence time for the first liquid in the second cavity has elapsed. Thereby, the second liquid enters from the second inlet into the widened capillary of the third fluidic switch. The second liquid Initially cannot enter the connecting capillary between the third fluidic switch and the second capillary, because there is a portion of the first liquid in this connecting capillary.

After the third fluidic switch has opened and the second liquid has entered the widened capillary downstream of the third fluidic switch, it has passed the junction of the third control capillary, which is joined to the widened capillary of the third fluidic switch. This control liquid flows through the third control capillary up to capillary stop of the second fluidic switch, which is disposed between the second cavity and the outlet. The second fluidic switch is opened, as soon as the control liquid has flowed through the third control capillary and has reached the capillary stop of the second fluidic switch.

The first inlet contains a residual amount of the first liquid until the second fluidic switch opens. After the opening of the second fluidic switch, the first liquid flows out of the first inlet and out of the first and second cavity further through the first, second, and third capillary to the outlet. The outlet contains, for example, an absorbent nonwoven material, which absorbs the liquids from the cavities and capillaries. Substantially as the last liquid, the second liquid flows out of the second inlet through the second cavity and the third capillary to the outlet. At least the second and third cavities are virtually free of the :first liquid. The third cavity can contain the second liquid or can be free of the second liquid, as soon as the suction pad in the outlet has become totally filled with liquid.

A sixth embodiment of the platform of the invention can comprise a plurality of differently configured transport paths for the liquid to be analyzed. The transport paths can run parallel to one another or they can be branched. In each transport path on a platform, a plurality of cavities can be present, which are intended for different purposes. In this type of platform, several features of a liquid to be manipulated can be analyzed simultaneously without a chemical reaction or after a chemical reaction. The analysis chambers can be adapted in shape, size, and location on the platform to the intended analytical evaluation.

Further embodiments of the platform of the invention can comprise the indicated microstructured elements in another arrangement in the transport path of the liquid to be manipulated.

The microfluidic elements can be used each alone in a platform of the invention for manipulating a liquid and exert their indicated action. If a plurality of the microstructured elements is interconnected in a platform for manipulating a liquid, a platform is obtained that can be adapted to different processes and used therefor. The process carried out with such a platform can be carried out only an increased cost by prior-art means.

For multi-step processes, a plurality of the microstructured elements can be arranged one after another. This type of chain of microfluidic elements can be branched or unbranched. A platform of the invention can comprise a plurality of chains of microfluidic elements, which can have a similar or different structure. All chains are generally supplied with the liquid to be manipulated from an inlet. Several different reactions or a single reaction-for parallel determinations-in the liquid to be manipulated, which run parallel to each other, can be carried out in a platform of this type-without outside intervention.

The platform of the invention, can be microstructured on one side and not covered. Further, on the microstructured side, it can be provided with a cover, which either contains no microstructures or is microstructured on the side facing the microstructure of the platform. The platform, microstructured on one side, can contain channels, which extend from the microstructured side to the non-microstructured side of the platform. The microstructure of the platform can be connected by means of such channels with a microstructure in the cover, which is present in the cover on its side facing the platform. This embodiment can be used to realize, for example, capillaries or control capillaries, which because of their line routing can be accommodated only with difficulty or not at all on the microstructured side of the platform.

The platform can be microstructured on at least two sides. In this case, it can be provided on at least one microstructured side with a cover, which is either unstructured or microstructured on its side facing the microstructure of the platform.

A platform that is microstructured on at least two sides can comprise channels that extend from the microstructure on one side of the platform to the microstructure on at least one other microstructured side of the platform.

A platform that is microstructured on at least two sides can be provided on at least one microstructured side with a cover, which cars be either unstructured or provided with a microstructure.

The platform of the invention comprises a microstructured system., which is suitable for a multitude of analyses in biology, biochemistry, chemistry, and medicine. All necessary elements are combined on the platform. The liquid to be analyzed moves by capillary force within and between the microstructured elements. The movement of the liquid on the platform can be controlled by selectively opened fluidic switches. Conclusions can be reached on states or processes, which have been provided or have occurred in the liquid itself or in the area of their source, in the analyzed liquid preferably from changes in its optical properties.

The microstructured platform can prepared, for example, directly by precision cutting machining and/or laser ablation and/or etching.

A mold insert can be prepared first whose microstructure is complementary to the desired structure of the platform. The mold insert can be produced by the aforementioned processes, by lithography or deep lithography with UV light or gamma-radiation and subsequent galvanic molding (LIGA process), or by means of another method. Using a mold insert, preferably made of metal, a large number of platforms can be produced by molding, for example, by injection molding or hot embossing.

The microstructured platform can consist of metal, such as nickel, nickel; cobalt, silicon, or gold. Further, it can consist of a—preferably transparent-plastic, preferably of polymethyl methacrylate, polyethylene ether ketone, polycarbonate, polystyrene, polyethylene terephthalate, or polybutylene terephthalate.

In a covered platform, the cover can be joined to the platform, by prior-art processes, for example, by gluing, bonding, ultrasonic welding, laser welding, lamination, or clamping.

The dimensions of the platform are in the range of 0.5 millimeters up to several centimeters. The outer shape of the platform is largely as desired. The platform can be a round disc (for example, with a 150-mm diameter and thickness of 2 mm, or with an 80-mm diameter and thickness of 3 mm), which can be turned stepwise during the manipulation of the liquid. Further, the platform can be a rectangular disc (for example, 75 mm·35 mm·3 min, or 65 mm·25 mm·2 mm, or 5 mm·5 mm·2.5 mm) or a cuboid (for example, 100 mm·100 mm·50 mm).

The dimensions of the cover of a fully covered platform in the cover area preferably match the area of the platform. In a partially covered platform, the dimensions of the cover are determined, for example, by the use of the platform.

The cover can be a film with a thickness of 10 μm to 400 μm. This film can also cover the filling openings and optionally the ventilation openings. The film can be pierced by means of a cannula of a filling syringe or by means of a needle for filling of a liquid to be manipulated and for ventilation of the microstructure. Further, the cover can be a plate with a thickness of 0.4 mm to 5 mm, which is provided with suitable openings at the filling openings and the ventilation openings of the platform.

The platform of the invention and thereby the carried out process have the following advantages:
The liquid is transported in the platform by capillary force. The effect of gravity or centrifugal force or the effect of a pressure difference is not necessary. The unavoidable action of gravity is negligible compared with the action of the capillary force.
The platform can be adapted to the desired course of the manipulation of the liquid.
The platform can be configured for multi-step reactions in the liquid to be manipulated.

In this case, reaction times of different length can be realized.
The time necessary, for example, for a reaction in a reaction chamber or for a process in a suspension chamber can be realized by the configuration of the control capillary and its connection point, thus without outside intervention. The required reaction time can be realized individually for each reaction chamber within a platform.
The path of the liquid to be manipulated can contain branches.
Several reactions can run simultaneously and/or one after another on a platform.
The analyses are performed reproducibly, they can be qualitative, semiquantitative, or quantitative.
The platform can also be manipulated safely by untrained persons.
The platform can be manufactured reproducibly in large numbers.
The process and the platform are suitable both for single samples of liquid and also for a liquid stream.
The amount of the liquid to be manipulated is preferably in the range of a few microliters or less.
The platform can contain reagents-preferably in dry or immobilized form-as integral components.
The platform can be used for a multitude of analyses particularly on physiological liquids, with which, for example, diseases, drugs, doping agents, and pathogenic and endogenous substances can be detected.
The platform and the process can be used for relatively complicated manipulation programs, in which more than one manipulation step is required, such as, for example, in immunity tests.
On the platform with microstructured regions for holding together a limited amount of liquid, a liquid amount applied in such regions is held together independent of the spatial position of the platform. The platform can be tilted horizontally, it can be turned upside down, or it can be moved jerkily.
The platform with metering means for the liquid to be manipulated can also be used, if the liquid to be manipulated need not be metered.

A few structural features of the platform of the invention will be described in greater detail below.

The liquid flow in the capillary is stopped at a capillary stop present in the platform of the invention, as soon as the front of the liquid flow in the capillary reaches the capillary stop.

A hydrophobic capillary stop within a capillary (at a constant cross section) is a region, which is not wetted by the present liquid. This type of region can be produced in a wettable capillary, when the surface of the capillary within the region of the capillary stop is made liquid-repellant (“hydrophobed” region in regard to the present liquid).

A geometric capillary stop is present, when the cross section of a capillary (with an unchanged wettability of the capillary) increases abruptly (capillary jump). In a capillary in the surface of a plate-with a rectangular cross section and capillary dimensions in both directions transverse to the lengthwise direction-a capillary stop is then also present, when the capillary is covered or not covered beyond the capillary jump. In this arrangement, no capillary jump is present in the wall formed by the cover of the capillary or on the open side of the capillary. Nonetheless, the abrupt widening of the capillary cross section only in a portion (for example, only three-fourths) of its circumference is a capillary stop.

Such capillary stops in a covered capillary can be overcome by the present liquid, if at the entrance to the capillary pressure is exerted on the liquid or if the pressure present there is increased, or if the pressure at the other end of the capillary is reduced.

On the other hand, a geometric capillary stop in the shape of a capillary jump can be overcome by the liquid without flow interruption, if a wedge-shaped notch is made at the end of the narrower capillary. The notch can extend from the wall of the narrower capillary to the wall of the widened capillary, or it can begin in the wall of the narrower capillary and gradually run into the wall of the capillary jump, as described in EP 1 013 341. The capillary force in the wedge edge of the notch is greater than in the capillary before the capillary jump. A manipulation to be performed outside the capillary is avoided by this structural feature. A capillary jump provided with a notch does not have an effect like a geometric capillary stop.

A geometric capillary stop in form of a capillary jump without a wedge-shaped notch can stop the flow of the liquid for a predefined time interval. The flow can be started again by means of a fluidic switch without outside manipulation after the elapse of the time interval. The fluidic switch comprises at least one capillary with a geometric capillary stop, therefore, a capillary jump without a wedge-shaped notch, and a control capillary, through which the liquid used to actuate the fluidic switch is led to the capillary stop and operas the fluidic switch. The control capillary discharges into the widened, capillary. The end of the control capillary can be provided with a wedge-shaped notch, or the control capillary discharges with gradual enlargement in its cross-sectional area into the widened capillary. The end of the control capillary can be located in one of the side walls of the widened capillary or in the wall of the capillary jump. Further, a side wall of the control capillary can transition continuously into the wall of the capillary jump and/or into a side wall of the widened capillary. Further, the bottom of the control capillary can transition continuously into the bottom of the widened capillary. Finally, a side wall and the bottom of the control capillary can transition continuously into a side wall of the widened capillary or into the wall of the capillary jump and/or into the bottom of the widened capillary. Further, the bottom of the control capillary can transition via multiple steps or a flat inclined ramp into the bottom of the widened capillary.

In all cases, the liquid flowing through the control capillary flows without delay into the widened capillary. This type of formed end of the control capillary does not have the effect of a capillary stop.

As soon as the liquid entering from the control capillary into the widened capillary contacts the liquid present at the capillary stop in the narrower capillary, the liquid stopped in the narrower capillary by the capillary stop flows beyond the capillary stop. The stream stopped in the narrower capillary is again “turned on.”

The narrower capillary with the capillary stop can be joined to a first liquid container, which supplies the narrower capillary with liquid. The control capillary, which leads to the widened capillary, can also be joined, on the one hand, to the first liquid container. In this case, the same first liquid is present in the narrower capillary and in the control capillary. The control capillary, which leads to the widened capillary, on the other hand, can be joined to a site, which contains a different second liquid. In the case of two liquid containers, the two containers can be filled with liquid at the same or different times.

If the narrower capillary and the control capillary are joined to the same liquid container, values, at which the liquid contained in the narrower capillary is stopped for a predefined time interval, can be selected for the dimensions of the control capillary in comparison with the dimensions of the narrower capillary up to the capillary stop. If the narrower capillary and the control capillary are joined to different liquid containers, the liquid can be filled into the second container at a later time than the liquid in the first container. In both cases, the length of the predefined time interval for stopping the liquid in the narrower capillary can be selected virtually as desired. The stop time during which the liquid in the narrower capillary is stopped by the capillary stop can amount to fractions of a second to many hours.

A fluidic switch with a geometric capillary stop and a control capillary with a rectangular cross section can have the following typical dimensions:

| | | |
|---|---|---|
| (Narrower) capillary before | Width | 5 μm to 3000 μm |
| the capillary stop: | Depth | 0.5 μm to 2000 μm |
| (Widened) capillary behind | Width | 10 μm to 4000 μm |
| the capillary stop: | Depth | 2 μm to 3000 μm |
| Control capillary: | Width, | 5 μm to 2000 μm |
| | Depth | 10 μm to 100 μm |
| | Volume | 0.01 μL to 10 μL |

| | |
|---|---|
| Stop time: | 0.1 seconds to 20 hours |

A fluidic switch with a capillary jump as a geometric capillary stop comprises in the simple case a narrower capillary, which transitions at the capillary jump into a widened capillary, and a single control capillary, which discharges into the widened capillary in the area of the capillary stop. A plurality of control capillaries, which discharge into the widened capillary in the area of the capillary stop, can be joined to a fluidic switch. This type of fluidic switch can be activated from several sites; it is opened from the site from which the control liquid emerges, which reaches the fluidic switch first.

Further, capillaries, into which the liquid enters, which after the opening of the fluidic switch flows into the widened capillary, can be joined to the widened capillary of a fluidic switch. These capillaries can be control capillaries, which lead a control liquid to other fluidic switches on the platform, or guide the liquid to other sites of the platform.

The platform of the invention far manipulating a liquid with microstructured elements, which are disposed in the transport path of the liquid, and the use of a platform of this type will be explained by the following examples and schematic figures.

### EXAMPLE 1a

### Platform with Two Reaction Chambers, a Fluidic Switch, and Metering Means

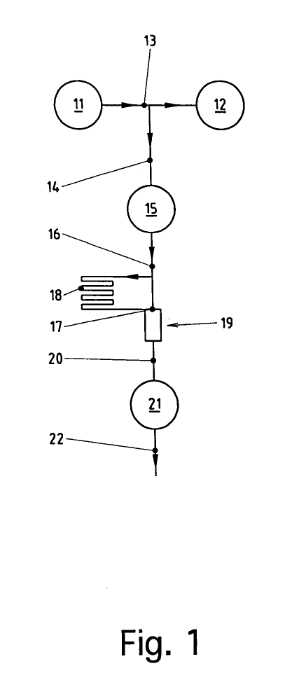

The platform is microstructured, for example, according to the schematic FIG. 1. The feed chamber (11) as an inlet is connected with the collection chamber (12) as the outlet by capillary (13). Capillary (14), which leads to the first cavity (15), which is made as a reaction chamber, branches off from capillary (13). Reaction chamber (15) contains a dry reagent. From reaction chamber (15), the narrower capillary (16) leads to the fluidic switch, which comprises the capillary stop (17) at the end of the narrower capillary (16) and the meander-shaped control capillary (18). The meander-shaped control capillary (18) branches off before the capillary stop (17) from the narrower capillary (16) and leads into the widened capillary (19), which joins the end of the narrower capillary (16). Capillary (20) leads from the widened capillary (19) to the second cavity (21), which is made as a reaction chamber. Reaction chamber (21) contains another dry reagent, which is tailored to the action of dry reagent provided in reaction chamber (15). Capillary (22) begins at reaction chamber (21) and ends at the capillary stop at the open end of capillary (22). Capillary (22) is used to ventilate chambers (15) and (21) and capillaries (14), (1.6), (18), (19), and (20) connected with these chambers, as soon as the liquid from capillary (13) enters capillary (14).

The volume of feed chamber (11) is somewhat greater than the sum of the volumes of capillary (14), chamber (15), and capillary (16). Because of the selected dimensions of capillaries (13), (14), and (16) and of cavity (15), the time between the entry of the liquid into capillary (14) and the arrival of the liquid at capillary stop (17) is less than the time which the liquid provided in feed chamber (11) requires to flow via capillary (13) into collection chamber (12). For this reason, the liquid flowing through capillary (13) separates from the liquid present in capillary (14) as soon as the end of the liquid flow in capillary (13) has passed the junction of capillary (14) and before the fluidic switch at the capillary stop (17) has been opened. A predefined aliquot of the provided liquid is present between the entrance to capillary (14) and capillary stop (17). After the opening of the fluidic switch, the separated metered aliquot flows from chamber (15) approximately totally into chamber (21), until the flow is stopped at the capillary stop at the end of the capillary (22). Chamber (21) is totally filled with the liquid to be manipulated.

The transitions from capillaries (13), (14), and (20) to cavities (12) and/or (15) and/or (21) are made without a capillary stop.

The microstructure is covered with a cover. The feed chamber has an opening for introducing the liquid to be analyzed and for ventilating the feed chamber. The collection chamber has a ventilation opening.

The microstructures have following typical dimensions

| | Length | Depth | Width | Diameter | Volume |
|---|---|---|---|---|---|
| | μm | μm | μm | μm | μL |
| Feed chamber (11) | (shape is largely as desired) | | | | 10 |
| Collection chamber (12) | (shape is largely as desired) | | | | 15 |
| Capillary (13) | 10,000 | 200 | 400 | — | — |
| Capillary (14) | 5000 | 100 | 200 | — | — |
| Reaction chamber (15) | 000 | 100 | 000 | 2000 | 0.3 |
| Narrower capillary (16) | 3000 | 100 | 200 | — | — |
| Control capillary (18) | 2000 | 50 | 200 | — | 0.02 |
| Widened capillary (19) | — | 200 | 300 | — | — |
| Capillary (20) | 3000 | 100 | 200 | — | — |
| Reaction chamber (21) | — | 100 | — | 2000 | 0.3 |
| Capillary (22) | — | 100 | 100 | — | — |

In the platform according to Example 1a, the following process steps occur without outside intervention, after a limited amount of the liquid to be analyzed was introduced into feed chamber (11), the liquid being transported solely by capillary force:
Transfer of an aliquot of the provided liquid from feed chamber (11) to collection chamber (12).
Introduction of a metered aliquot of the filled liquid via capillary (14) into chamber (15) up to capillary stop (17) and stopping of the liquid for a predefined time interval,
Separation of the metered aliquot from the rest of the limited amount of liquid, after the end of the liquid flow from chamber (11) into chamber (12) has passed the entrance into capillary (14),
Uptake of the first reagent provided in chamber (15) and reaction between the liquid to be analyzed and the first reagent during a predefined residence time of the liquid in chamber (15),
Conveying of the liquid from chamber (15) into chamber (21), after the fluidic switch, after elapse of the predefined stop time, has been opened by the control liquid from control capillary (18),
Uptake of the second reagent provided in chamber (21) and reaction between the liquid to be analyzed and the second reagent,
Visual evaluation or photometry of the change, which has or has not occurred in analysis chamber (21).

Because of the configuration of the platform, a metered amount of the provided liquid is used for this test. The test proceeds in a defined and reproducible manner with the metered amounts of the reagents provided in chambers (15) and (21). Thereby, a feature of the provided liquid can be determined from an optical change in chamber (21).

### EXAMPLE 1b

### Detection of Human Chorionic Gonadotropin (hcG) by Means of a Platform with Two Reaction Chambers, a Fluidic Switch, and Metering Means

To detect hcG in urine, a first hcG-specific antibody, which is attached to dye-labeled resuspendable latex particles, is introduced into the first reaction chamber (15). The second reaction chamber (21) contains a resuspendable second hcG-specific antibody.

The test can proceed as follows: The urine sample is introduced by means of a pipette or syringe into the feed chamber, of a predefined part of the platform is dipped into the urine until the feed chamber is filled. The liquid flows through capillary (13) into collection chamber (12) and through capillary (14) into reaction chamber (15) and fills this chamber and the narrower capillary (16), until the flow is stopped at capillary stop (17). A substream of the liquid enters the meander-shaped control capillary (18) from the narrower capillary (16) and reaches the widened capillary (19) only after the elapse of a stop time and opens the fluidic switch. The stop time in the shown platform is about 60 seconds.

The dry reagent present in the first reaction chamber is resuspended by the provided liquid and distributed by diffusion in the liquid. hcG present in the liquid is bound to the first hcG antibody. As soon as the fluidic switch has opened, the liquid with bound and free first antibody flows by means of capillary force into the second reaction chamber (21), in which only an hcG-bound first antibody from the first reaction chamber is agglutinated.

If no hcG is present in the provided liquid, the liquid in chamber (21) contains no agglutinated latex particles. If hcG is present in the provided liquid, the liquid in chamber (21) contains agglutinated latex particles, which can be detected from the increased content of dye, in contrast to non-agglutinated latex particles, which cannot be detected.

If chamber (21) is large enough and can be seen visually, the experienced observer can decide qualitatively whether hcG is present or not present in the provided liquid. For series tests, the color intensity can be measured automatically by photometry.

### EXAMPLE 2a

### Platform with Two Reaction Chambers, a Plurality of Fluidic Switches, and a Washing Device

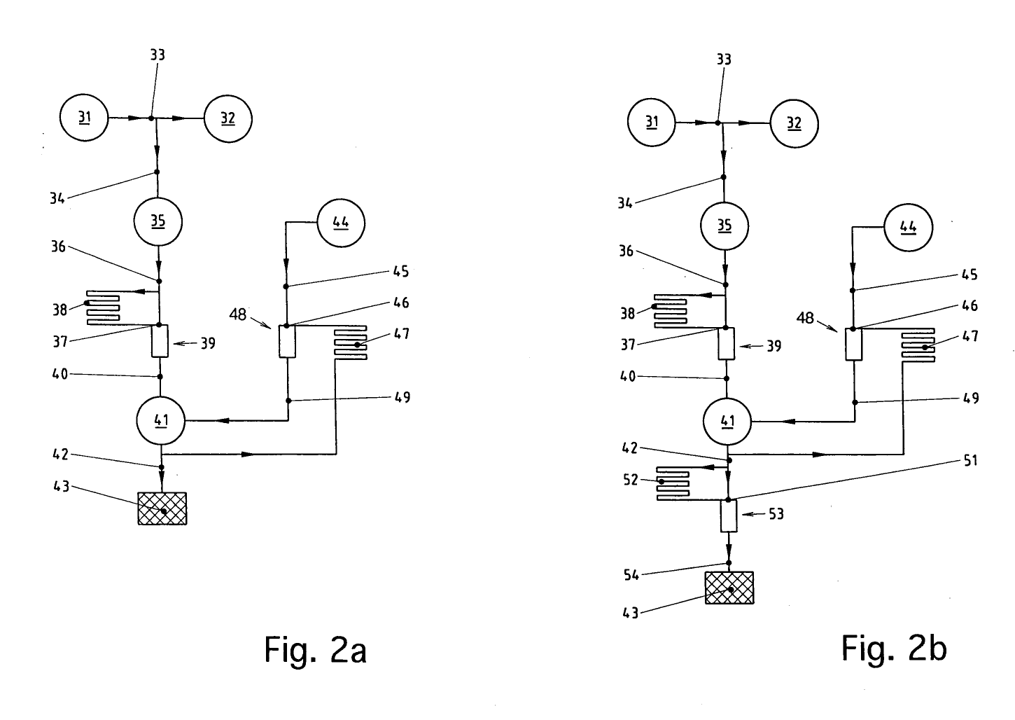

The platform used for this test comprises initially the microstructures shown in schematic FIG. 2a. Feed chamber (31) as an inlet is connected with collection chamber (32) as the outlet by capillary (33). Capillary (34), which leads to the first cavity (35), which is made as a reaction chamber, branches off from capillary (33). Reaction chamber (35) contains a dry reagent. From reaction chamber (35), the narrower capillary (36) leads to the fluidic switch, which, comprises the capillary stop (37) at the end of the narrower capillary (36) and the meander-shaped control capillary (38). The meander-shaped control capillary (38) branches off before capillary stop (37) from the narrower capillary (36) and leads into the widened capillary (39), which joins the end of the narrower capillary (36). Capillary (40) leads from the widened capillary (39) to the second cavity (41), which is designed as a reaction chamber. Reaction chamber (41) contains another dry reagent, which is tailored to the action of dry reagent provided in reaction chamber (35). From reaction chamber (41), capillary (42) leads to cavity (43), which contains an absorbent pad for liquid. The absorbent pad in, the cavity (43) can take up a liquid amount, which, for example, is three times as large as the metered aliquot, which has been separated from the liquid provided in chamber (31).

Further, cavity (44) is provided, from which the narrower capillary (45) leads to the fluidic switch, which comprises the capillary stop (46) at the end of the narrower capillary (45) and the meander-shaped control capillary (47). The meander-shaped control capillary (47) branches off from capillary (42) and leads into the widened capillary (48), which connects to the narrower capillary (45). Capillary (49) leads to cavity (41) from the widened capillary (48). If necessary, the capillary (49) can be joined to capillary (34) before cavity (35).

The volume of feed chamber (31) is greater than the sum of the volumes of capillary (34), chamber (35), and capillary (36). Because of the selected dimensions of capillaries (33), (34), and (36) and of cavity (35), the time between the entry of the liquid into capillary (34) and the arrival of the liquid at capillary stop (37) is less than the time the liquid provided in feed chamber (31) requires to flow through capillary (33) into collection chamber (32). The liquid flowing through capillary (33) separates from the liquid present in capillary (34) as soon as the end of the liquid flow in, capillary (33) has passed the junction of capillary (34). A predefined aliquot of the provided liquid is present between the entrance to capillary (34) and capillary stop (37).

FIG. 2b presents a variant of the platform of FIG. 2a. The capillary (42) leading out of cavity (41) leads to a fluidic switch, which comprises the capillary stop (51) at the end of the narrower capillary (42) and the meander-shaped control capillary (52). The meander-shaped control capillary (52) branches off from the narrower capillary (42) before the capillary stop (51) and leads into the widened capillary (53), which joins to the end of the narrower capillary (42). From the widened capillary (53), capillary (54) leads to cavity (43), which, contains an absorbent pad for liquid.

The liquid contained in capillary (34)—and optionally in cavity (35)—is stopped at capillary stop (37), until the metered partial volume of the liquid to be manipulated has been formed, i.e., until the liquid stream in capillary (33) has stalled at the start of capillary (34) and until the reaction proceeding optionally in cavity (35) has ended.

The liquid which has flowed through capillary (40) and cavity (41) is stopped at capillary stop (51). Only then does the liquid that has flowed through control capillary (47) to capillary stop (46) open the fluidic switch and release the path for the liquid from cavity (44) to cavity (41). The liquid from cavity (44), however, does not flow to cavity (41), because the liquid in cavity (41) no longer flows and capillary (49) is not ventilated.

The liquid is stopped at the capillary stop (51) until the reaction in cavity (41) has ended. After this, the control liquid from capillary (52) opens the fluidic switch, and the liquid flows from cavity (41) via capillary (54) to the absorbent pad in the cavity (43). At the same time, the flow of the liquid from cavity (44) via cavity (41) to the absorbent pad begins.

The flow in capillary (54), on the one hand, can continue until all of liquid from cavities (41) and (44) has entered the absorbent pad and cavity (41) no longer contains a liquid. On the other hand, the flow of the liquid in capillary (54) can end as soon as the absorbent pad is saturated with liquid and cavity (41) is still filled with liquid from cavity (44).

The microstructure is covered with a cover. The feed chambers (31) and (44) each have au opening for introducing the liquid to be analyzed and for ventilating the feed chambers. Collection chamber (32) and chamber (43) each have a ventilation opening.

The microstructures—apart from control capillaries (38), (47), and (52)—have the dimensions as stated in Example 1a. The control capillaries (38), (47), and (52) are configured for different stop times.

The liquid volume, present in control capillary (38), is a few percentages of the liquid volume, flowing via the fluidic switch, controlled and opened by control capillary (38), from cavity (35) to cavity (41). The liquid volume, present in control capillary (47), is a few percentages of the liquid volume, flowing via the fluidic switch, controlled and opened by control capillary (47), from cavity (44) to cavity (41). The liquid volume, present ill control capillary (52), on the contrary, can constitute a notable portion of the liquid volume, flowing via the fluidic switch, controlled and opened by control capillary (52), from cavity (44) to cavity (41). The liquid flowing from cavity (41) to cavity (43) is no longer necessary for the test and is discarded.

The transitions of capillaries (33), (34), (40), (42 or 54), and (49) into the cavities (32) and/or (35) and/or (41) and/or (43) and/or (41) are made without a capillary stop.

In the platform according to Example 2a, a limited amount of the liquid to be analyzed is introduced into feed chamber (31) and a second liquid into feed chamber (44). It can be expedient to introduce the second liquid into chamber (44) first. The liquid in chamber (44) is stopped at capillary stop (46) until the fluidic switch has been opened by means of the liquid from control capillary (47).

In the platform according to Example 2a, the following process steps proceed without outside intervention, the liquids being transported solely by capillary force:
Transfer of an aliquot of the provided liquid from feed chamber (31) to collection chamber (32),
Introduction of a metered aliquot of the filled liquid via capillary (34) into the chamber (35) up to capillary stop (37) and stopping of the liquid for a predefined time interval,
Separation of the metered aliquot from the rest of the limited liquid volume, after the end of the liquid flow from chamber (31) into chamber (32) has passed the entrance of capillary (34),
Uptake of the first reagent provided in chamber (35) and reaction between the liquid to be analyzed and the first reagent for a predefined residence time of the liquid in chamber (35),
Conveying of the liquid from chamber (35) into chamber (41), after the fluidic switch has been opened after the elapse of the predefined stop time,
Uptake of the second reagent provided in chamber (41) and reaction between the liquid to be analyzed and the second reagent.

In the embodiment of the platform according to FIG. 2a, the following process steps follow:
Conveying of all of the liquid from chamber (41) into the absorbent pad in cavity (43),
Introduction of a liquid, which has not passed chamber (35), from feed chamber (44),
“Washing” of the solid substances present in chamber (41) by means of the liquid from chamber (44) by conveying the liquid into the absorbent pad in cavity (43),
Filling of chamber (41) with liquid, which has not passed chamber (35), from, chamber (44), after the liquid from chamber (41) has been largely absorbed by the absorbent pad,
Visual evaluation or photometry of the change, which has or has not occurred in analysis chamber (41).

In the embodiment of the platform according to FIG. 2b, the following process steps follow:
Conveying of the liquid from chamber (41) up to capillary stop (51) and stopping of the liquid at capillary stop (51),
Withdrawal of a portion of the liquid from chamber (41) via control capillary (47) to the fluidic switch with capillary stop (46) and opening of this fluidic switch,
Supplying the liquid from chamber (44) to chamber (41),
Opening of the fluidic switch by means of the liquid, which is supplied via control capillary (52) of widened capillary (53), after chamber (44) has been linked to chamber (41) in terms of flow,
“Washing” of the solid substances present in chamber (41) by means of the liquid from chamber (44) by conveying the liquid into the absorbent pad in cavity (43),
Filling of chamber (41) with liquid, which has not passed chamber (35), from chamber (44), whereby the liquid from chamber (44) enters chamber (41) before the liquid from chamber (35) has left chamber (41),
Visual evaluation or photometry of the change, which has or has not occurred in analysis chamber (41).

In the embodiment of the platform according to FIG. 2b, the liquid, which has entered capillary (42) from chamber (35) via chamber (41), is stopped until the reaction of the liquid from chamber (35) with the reagent in chamber (41) has been completed. The fluidic switch is then opened by means of the liquid from control capillary (52). The liquid originating from chamber (35) is completely taken up by the absorbent pad in cavity (43). For the optical evaluation of the change, which has or has not occurred in analysis chamber (41), chamber (41) can be filled with the “washing liquid” from chamber (44), or chamber (41) can be free of liquid. In the first case, the absorbent pad in cavity (43) is already saturated with liquid before all of the liquid provided in chamber (44) (and originating from chamber (35)) has flowed away through chamber (44). In the second case, all of the liquid provided in chamber (44) (and originating from chamber (35)) has flowed into the absorbent pad before the absorbent pad is saturated with liquid.

### EXAMPLE 2b

### Detection of Human Chorionic Gonadotropin (hcG) with an Internal Washing Step by Means of a Platform with Two Reaction Chambers and a Plurality of Fluidic Switches

To detect hcG in urine, the first reaction, chamber (35) is made as a resuspension chamber. It contains resuspendable, dried, dye-labeled hcG antibodies of the first type. The second reaction chamber (41) contains non-resuspendable hcG antibodies of the second type, which are immobilized on its interior surface and are specific for a different epitope of the hcG hormone.

The detection proceeds as follows: The urine sample is introduced into feed chamber (31) by means of a pipette or syringe and the feed chamber is filled. The liquid flows by capillary force via capillary (33) into collection chamber (32) and via capillary (34) into resuspension chamber (35) and fills this chamber and the narrower capillary (36) until the flow is stopped at the capillary stop (37). A substream of the liquid enters the meander-shaped control capillary (38) from the narrower capillary (36) and reaches the widened capillary (39) only after the elapse of a stop time and opens the fluidic switch. The stop time of the fluidic switch with control capillary (38) constitutes about 1 minute.

The provided liquid in the resuspension chamber takes up the resuspendable dried hcG antibodies of the first type. The hcG-bound antibodies of the first type and free antibodies, optionally present in excess, flow with the liquid into reaction chamber (41). There, hcG antibodies of the first type bind to antibodies of second type. A fixed sandwich-like molecular complex forms in the reaction chamber. The liquid in reaction chamber (41) optionally contains free, suspended, dye-labeled hcG antibodies of the first type. These are to be flushed out of reaction chamber (41) before the fixed molecular complex can be detected in the chamber. Otherwise, the intrinsic color of the resuspended hcG antibodies of the first type hinders or prevents this detection. This washing step is absolutely necessary in practical terms.

A second liquid, which is used as the washing liquid, is filled into feed chamber (44) to flush resuspended antibodies of the first type, not bound to hcG and optionally still present in reaction chamber (41), out of the reaction chamber. The second liquid can be identical with the liquid filled into feed chamber (31) or it can be different therefrom, for example, distilled water. Chamber (44) is filled with the second liquid immediately after the filling of the first chamber or at a later time. The time interval between the filling of both chambers (31) and (44) is determined by the reactions occurring in chambers (35) and (41), or by other considerations.

The liquid filled into chamber (44) flows through capillary (45) to the fluidic switch, which comprises the capillary stop (46) at the end of the narrower capillary (45), the widened capillary (48), and the control capillary (47). The widened capillary (48) is connected via capillary (49) with chamber (41). The control capillary (47) branches off from capillary (42). The control capillary is filled after chamber (41) has been totally filled with liquid from chamber (35) and this liquid has reached capillary stop (51). The control liquid reaches capillary stop (48) sand opens this fluidic switch before the fluidic switch at capillary stop (51) is opened. The washing liquid enters reaction chamber (41) from filling chamber (44). The liquid present there, which has flowed in via resuspension chamber (35) and contains the optionally resuspended antibodies not bound to hcG, is displaced and replaced by the “washing liquid” from chamber (44).

If no hcG is present in the provided liquid, the liquid in chamber (41) contains no agglutinated latex particles. If hcG is present in the provided liquid, the liquid in chamber (41) contains agglutinated latex particles, which can be detected from the increased dye content, in contrast to non-agglutinated latex particles, which cannot be detected.

If chamber (41) is large enough and can be seen visually, the experienced observer can decide qualitatively whether hcG is present or not present in the provided liquid. For series test, the color intensity can be measured automatically by photometry.

A liquid that contains no resuspended hcG antibodies of first type is to be used as the “washing liquid.” The “washing liquid” therefore may not have flowed via resuspension chamber (35).

If capillary (45) is joined to collection chamber (32), the excess portion of the urine sample itself can be used as the “washing liquid.” The washing process in this embodiment as well is begun as soon as the fluidic switch with capillary stop (46) and control capillary (47) has been opened, as well as the fluidic switch with capillary stop (51) and control capillary (52).

In analysis chamber (41), the content of hcG is determined analogously to the process disclosed in Example 1b.

### EXAMPLE 3a

### Platform with Metering Means, Two Fluidic Switches, and Three Reaction Chambers in Two Analysis Branches

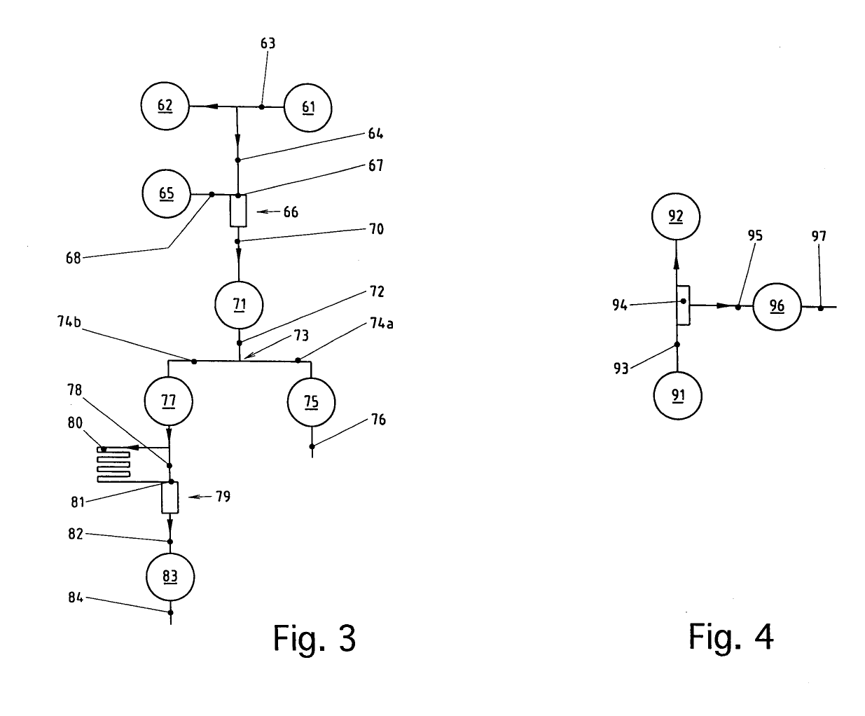

The platform shown in schematic FIG. 3 comprises the inlet (61), which is connected by capillary (63) with outlet (62). Capillary (64), which leads to the fluidic switch with a capillary jump as the geometric capillary stop (67) at the end of the narrower capillary (64), branches off from capillary (63). Control capillary (68), which is connected with cavity (65), discharges into the widened capillary (66) of the fluidic switch. Further, the fluidic switch is connected via capillary (70) with cavity (71), to which capillary (72) is joined, which leads to the branching point (73). At the branching point (73), capillary (72) divides into the two capillaries (74a) and (74b). The volume ratio of the two substreams can be set by the ratio of the cross-sectional areas of the branched capillaries.

Capillary (74a) leads to the cavity (75), from which a capillary (76) with an open end runs out. Capillary (74b) leads to cavity (77), from which capillary (78) leads to the fluidic switch, which comprises geometric capillary stop (81) at the end of the narrower capillary (78) and the meander-shaped control capillary (80). The meander-shaped control capillary branches off from capillary (78). The fluidic switch is connected by the widened capillary (79) and capillary (82) with cavity (83), from which a capillary (84) with an open end runs out. The cavities and capillaries of the platform are covered, apart from inlet (61), outlet (62), and cavity (65). The open end of capillaries (76) and (84) are used for ventilating the covered microstructures as soon as the liquid to be manipulated enters capillary (64).

A limited aliquot of the liquid to be manipulated is introduced into inlet (61). A second liquid is introduced in the cavity (65), after which the metered aliquot of the liquid to be manipulated has separated from the rest of the liquid to be manipulated introduced into inlet (61).

In the platform according to Example 3a, the following process steps proceed without outside intervention, the liquids being transported solely by capillary force:
Transfer of an aliquot of the liquid to be manipulated from inlet (61) to outlet (62),
Introduction of the liquid to be manipulated into capillary (64) and stopping of the liquid at capillary stop (67),
Separation of the metered aliquot from the rest of the liquid to be manipulated, after the end of the liquid flow from inlet (61) to outlet (62) has passed the entrance of capillary (64),
Opening of the fluidic switch by the liquid, which enters the widened capillary (66) via control capillary (68) from cavity (65) and can be a liquid for diluting the metered aliquot from capillary (64),
Combined flow of the metered aliquot from capillary (64) and cavity (65) via capillary (70) into cavity (71), which can be configured as a mixing chamber for the two liquids entering together; the two liquids are mixed in the mixing chamber preferably by diffusion,
Conveying of the mixed liquid from cavity (71) to branching point (73) and dividing of the liquid stream between capillaries (74a) and (74b),
Reaction of a reagent provided in cavity (75) with the diluted liquid to be manipulated, which enters capillary (76) and is stopped at the capillary stop at the end of capillary (76),
Reaction of a reagent provided in cavity (77) with the diluted liquid to be manipulated, which enters capillary (78) and is stopped at capillary stop (81) for a predefined stop time, until the control liquid from control capillary (80) opens the fluidic switch,
Conveying of the liquid from cavity (77) to cavity (83),
Reaction of a reagent provided in cavity (83) with the diluted liquid to be manipulated, which enters capillary (84) and is stopped at capillary stop at the end of capillary (84),
Visual evaluation or photometry of the changes, which have or have not occurred in cavities (75) and (83).

Different reactions proceed side by side in the substreams via capillaries (74a) and (74b). The result of the two reactions is determined in the liquids, contained in cavities (75) and (83), based on an optical feature, These two cavities are the analysis chambers.

The platform shown in FIG. 3 can be modified, for example, as follows:
If the liquid to be manipulated is not to be diluted, or if the liquid to be manipulated has been diluted outside the platform before introduction into inlet (61), the cavities (65) and (71) and the capillary (68) can be omitted.
If an unmetered amount of the liquid to be manipulated is to be analyzed, the liquid to be manipulated can be introduced into cavity (71). The microstructures (61) to (68) located before the cavity can be omitted. It can be expedient to retain capillary (70) and to allow the liquid to be manipulated to enter the entrance of this capillary. The introduced amount must be sufficiently large, so that the downstream microstructures are filled with the liquid in both branches up to the open end of capillaries (76) and (84).
If several reagents are used for the pretreatment of the liquid to be manipulated, this can be accommodated in cavities (61) and/or (65) and/or (71).
A dried reagent can be accommodated-apart from a cavity in a capillary.
The cavities, in which reagents are accommodated, can be provided in areas with microstructures for holding a limited amount of liquid, together. In such regions, a limited amount of liquid can be held together, which is greater than the amount of liquid that can be held together in regions of equal size without microstructures.
The cavity (65) can contain a predefined metered amount of a liquid, which is introduced before the platform is covered. b this case, the cavity (65) is covered and initially has no connection to capillary (68). To use the platform, the block between cavity (65) and capillary (68) can be opened-for example, by thumb pressure or by piercing with a needle. At the same time, the cavity is provided with a ventilation opening. In this way, the filling of a liquid during use of the platform can be avoided, which is especially expedient with a very small amount of liquid-which is laborious to meter in-in cavity (65).

### EXAMPLE 3b cl Immunochemical Determination of HbAlc and Hb in Blood by Means of a Platform with Metering Means, Two Fluidic Switches, and Three Reaction Chambers in. Two Analysis Branches

For the determination of the hemoglobin content Hb and of the content of hemoglobin AIc in whole blood, the platform disclosed in Example 3a can be used, which is provided with the following reagents:
Reaction chamber (75) contains in dried form 10 μg (33 μmol) of ferricyanide K3 (Fe(CN)6) per μL of whole blood.
Reaction chamber (77) contains a HbAlc antibody, for example, a polyclonal HbAlc antibody, and a detergent (for example, sodium dodecyl sulfate) in dried form.
Reaction chamber (83) contains a dried polyhapten agglutinator.
For later filling in cavity (65), an aqueous solution of a buffer (for example, 0.1 mol phosphate buffer at pH=7.0) and a lysis reagent (for example, 10 μg of saponin per μL of whole blood) is kept ready for dilution and lysis of whole blood.

The determination proceeds as follows:

Approximately one drop of whole blood is introduced into the open inlet (61) and is transported through capillary (63) to outlet (62). The metering capillary (64) has a volume of t μL between its branching off from capillary (63) and capillary stop (67). Capillary (64) fills with whole blood as soon as the end of the flow in capillary (63) has passed the branching of capillary (64); the metered amount of blood is separated in the metering capillary (64) from the rest of the blood.

Next, 55 μL of the kept ready aqueous solution of buffer and lysis reagent is added to cavity (65). This solution is transported by capillary force via control capillary (68) to the fluidic switch, where it enters the widened capillary (66) and opens the fluidic switch.

The metered and separated amount of whole blood is transported from capillary (64) together with the aqueous solution from cavity (65) via capillary (70) to cavity (71). Both liquids combine preferably by diffusion. The metered amount of whole blood is diluted, and the blood cells are lysed by the lysis reagent,

Cavity (71) has a volume of about 60 μL. After about 1 minute, the approximately 55 μL of diluted blood has been transported with the lysed blood cells to cavity (71). The liquid is transported by means of capillary force through capillary (72) to branching (73). There, the liquid stream divides into two substreams approximately equal in size.

About 25 μL is transported via capillary (74a) to cavity (75). The capillary (76) is filled. The flow is stopped at the open end of capillary (76), which is made as a geometric capillary stop. Capillary (76) and cavity (75), having a volume of, about 20 μL, are filled with liquid. The liquid dissolves the dried reagent in cavity (75), and the hemoglobin reacts with the reagent.

About 25 μL is transported via capillary (74b) to cavity (77). There, the liquid reacts with the provided reagent. The liquid is stopped at capillary stop (81). After the stop time of about 80 seconds has elapsed at the fluidic switch, the fluidic switch is opened by the liquid, which was supplied through control capillary (80) and entered widened capillary (79). The liquid is transported further by capillary force to cavity (83), which has a volume of about 12 μL, and capillary (84) is filled. The flow is stopped at the open end of capillary (84), which is made as a geometric capillary stop. Capillary (84) and cavity (83) and a portion of capillary (82) ate filled with liquid. The widened capillary (79) and the cavity (77) are virtually free of liquid. The liquid in cavity (83) reacts with the agglutinator.

The content of Hb and HbAlc is determined in the analysis chambers (75) and (83) by turbidity measurement.

### EXAMPLE 4a

### Platform with a Capillary Gap and Metering Means

The platform shown in schematic FIG. 4 comprises the inlet (91), which is connected by capillary (93) with the outlet. The capillary gap (94), which is connected via capillary (95) with cavity (96), branches off from capillary (93). Capillary (97), whose open end is used for ventilating the covered microstructures, as soon as the particle-containing liquid to be manipulated enters the capillary gap, leads out of cavity (96). The volume between the entrance to capillary gap (94) and the open end of capillary (97) is predefined by the microstructure; this volume contains the metered amount of the aliquot of the liquid separated via the capillary gap.

A limited aliquot of the particle-containing liquid to be manipulated is introduced into inlet (91). Cavity (96) can contain dried reagent.

In the platform according to Example 4a, the following process steps proceed without outside intervention, the liquid to be manipulated being transported solely by capillary force.
Transfer of an aliquot of the liquid to be manipulated from inlet (91) to outlet (92),
Introduction of the liquid to be manipulated into capillary gap (94) and separation of an aliquot from the particle-containing liquid to be manipulated,
Conveying of the separated aliquot via capillary (95) to cavity (96),
Filling of cavity (96) and optionally reaction of the reagent provided in cavity (96) with the separated aliquot of the liquid,
Filling of capillary (97) up to capillary stop at the open end of capillary (97),
Stopping of the liquid stream as soon as the liquid has reached the open end of capillary (97),
Visual evaluation or photometry of changes, which have or have not occurred in cavity (96).

The platform shown in FIG. 4 can be modified, for example, as follows:
Cavity (96) joins the capillary gap directly; capillary (95) is omitted.
Capillary (97) leads into at least one further cavity; the last of a plurality of successive cavities is provided with a capillary that has an open end.
A plurality of capillary gaps branch off capillary (93) at a distance from one another, each of which is connected with at least one cavity. The plurality of branches case have a different volume and be used for different analyses, which proceed virtually simultaneously.

### EXAMPLE 4b

### Determination of Glucose in Blood Plasma by Means of a Platform with a Capillary Gap and Metering Means

The platform disclosed in Example 4a contains in cavity (96) dried Trinder reagent, which contains glucose oxidase and peroxidase and, for example, 4-aminoantipyrine as the (initially red) indicator dye. Gluconic acid and, hydrogen peroxide, which is reduced by peroxidase to water, form during oxidation of glucose. The (initially red) indicator dye is changed into a blue dye by the oxygen being released thereby. The extinction at a wavelength of 500 nm is proportional to the plasma glucose concentration.

The determination proceeds as follows:

Several drops of whole blood are introduced into the open inlet (91) and transported through capillary (93) to outlet (92) by means of capillary force. As soon as the blood stream flows by capillary gap (94), a portion of the plasma enters the capillary gap. The separated plasma is free of blood cells; it flows via capillary (95) into cavity (96) and fills this cavity and capillary (97). As soon as the flow has reached the open end of capillary (97), the flow in capillary (95) and in cavity (96) is stopped at the capillary stop.

The plasma, contained in cavity (96), resuspends the dried Trinder reagent, which reacts with the glucose contained in the plasma. In so doing, the plasma in cavity (96) turns blue. The extinction at 500 nm is a quantitative measure for the glucose content in the separated plasma and thereby in the provided whole blood.

### EXAMPLE 5a

### Platform with a Plurality of Cavities, Washing Device, and a Plurality of Fluidic Switches

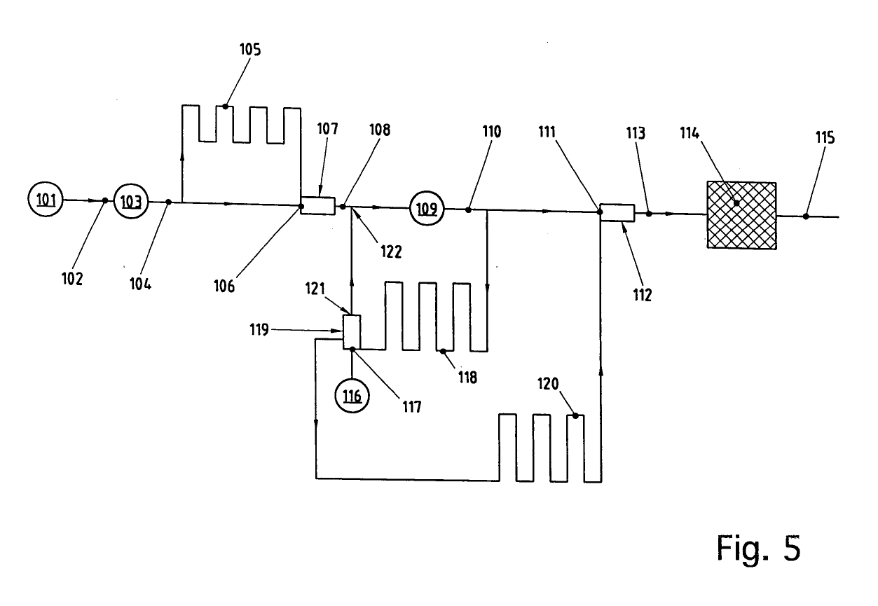

The platform shown in schematic FIG. 5 comprises the first Inlet (X01), which is connected by the first capillary (102) with the first cavity (103). The second capillary (X04 with 108) connects the first cavity (103) with the second cavity (109). The first fluidic switch (107) is located before the second cavity (109). The first control capillary (105) branches off from the second capillary (104) and leads to capillary stop (106) in the first fluidic switch. The third capillary (110 with 113) leads from the second cavity (109) to outlet (114). Outlet (114) is connected via the last capillary (115) with the environment. The open end of the last capillary (115) Is provided with a capillary stop and serves to ventilate the covered capillaries and cavities. The second fluidic switch (112) is disposed between the second cavity (109) and outlet (114).

At site (122), the connecting capillary branches off from the second capillary (108), which leads at site (121) to the widened capillary of the third fluidic switch (119). The second control capillary (118) branches off from capillary (110) and leads into the widened capillary to capillary stop (117) of the third fluidic switch (119). The third fluidic switch (119) is connected via a capillary with the second inlet (116).

The third control capillary (120) leads from the widened capillary of the fluidic switch (119) into the widened capillary to the capillary stop (111) of the second fluidic switch (112).

The first cavity (103) is provided in an area of its bottom, for example, with columnar microstructures to hold together a limited amount of a liquid. The first cavity (103) contains a first substance, for example, a dried resuspendable substance, in the area provided with. microstructures. The second cavity (109) contains a reagent, for example, an immobilized reagent. Outlet (114) contains a nonwoven material, which functions as an absorbent pad.

A limited amount of the first and/or second liquid to be manipulated is introduced into the first inlet (101) and into the second inlet (116), in each case, for example, a simple liquid into the first inlet (101) and a washing liquid into the second inlet (116).

In the platform according to Example 5a, the following process steps proceed without outside intervention, the two liquids to be manipulated being transported solely by capillary force.
Transporting of the sample liquid from inlet (101) via capillary (102) into resuspension chamber (103) and further to capillary stop (106) of the first fluidic switch (107),
Resuspending the dried substance provided in the first cavity (103),
Stopping the sample liquid at the capillary stop (106) for the duration of the predefined resuspension time,
Opening of the fluidic switch (107) after the elapse of the predefined resuspension time by the aliquot of the sample liquid transported during the resuspension time via control capillary (105) to fluidic switch (107) from capillary (104),
Transporting of the sample liquid, which contains the resuspended substance from the resuspension chamber, to reaction. chamber (109) and further up to the capillary stop of the second fluidic switch (112), and penetration of the sample liquid into the connecting capillary joined to the branching (122), which fills the connecting capillary up to capillary stop (121) and is stopped at capillary stop (121),
Reaction of the sample liquid in reaction chamber (109) with the provided immobilized reagent,
Stopping of the sample liquid at capillary stop (111) and reaction of the sample liquid with the immobilized reagent in the reaction chamber for the duration of the predefined reaction time,
Opening of fluidic switch (119) by the control liquid branched from capillary (110) via control capillary (118),
Transporting of the washing liquid from inlet (116) into the widened capillary up to capillary stop (121) and stopping the washing liquid at capillary stop (121),
Opening of fluidic switch (112) by the aliquot of the washing liquid branched from fluidic switch (119) via control capillary (120) after the elapse of the predefined reaction time ilk reaction chamber (109),
Transporting of the sample liquid, which has reacted with the immobilized reagent in reaction chamber (109), via the opened fluidic switch (112) to outlet (114) and absorption initially of the reacted sample liquid by the nonwoven material,
Subsequent flow of the washing liquid first stopped at capillary stop (121) via the connecting capillary to branch (122) and further through reaction chamber (109) and through capillary (110 with 113) to outlet (114), whereby the washing liquid pushes forward the sample liquid contained first in these capillaries and in the reaction chamber,
Flushing of the sample liquid out of the reaction chamber with the washing liquid.

As a result, the washed immobile reaction product of a reactive component in the sample liquid and the immobilized reagent provided in the reaction chamber is present in reaction chamber (109). After the washing process, the reaction chamber no longer contains virtually any sample liquid and any resuspended reagent. The reaction. chamber can contain washing liquid, or the washing liquid can be sucked virtually totally out of the reaction chamber.

The immobile washed reaction product in the reaction chamber is determined by means of a method tailored to the type of reaction product.

### EXAMPLE 5b

### Detection of Human C-Reactive Protein (CR)P) in a Liquid by Means of a Platform with a Plurality of Cavities, a Washing Device, and a Plurality of Fluidic Switches

The platform disclosed in Example Sa contains dried, resuspendable, fluorescent dye-labeled anti-CRP antibodies of the first type in the resuspension chamber (103). Reaction chamber (109) contains non-resuspendable immobilized anti-CRP antibodies of second type. The inlet (116) contains a buffered washing liquid.

The sample liquid to be analyzed for CRP is introduced into Inlet (101) and is transported by capillary force into the resuspension chamber and up to fluidic switch (107) and stopped there. During the incubation period of about 5 minutes, the fluorescent dye labeled anti-CRP antibody of the first type is resuspended in the sample liquid, and the CRP is bound to the resuspended antibody of the first type. After the opening of the fluidic switch (107), the sample liquid is transported by capillary force into reaction chamber (109). The sample liquid now contains free, suspended, labeled anti-CRP antibodies of the first type and complexes of CRP and labeled anti-CRP antibodies of the first type. In reaction chamber (109), the labeled complexes bind to the anti-CRP antibodies of second type immobilized in the reaction chamber. The action has ended after an incubation period of about 5 minutes. The amount of the fluorescent dye-labeled anti-CRP antibody of first type, bound to the immobilized anti-CRP antibody of second type, is proportional to the CRP amount in the provided sample liquid. The reaction chamber is flushed after the opening of the fluidic switch (112) with the washing buffer from inlet (116). In so doing, the free, fluorescent, dye-labeled, suspended anti-CRP antibody of the first type is flushed out of the reaction chamber and transported with the liquid to outlet (114).

The immobile complex, contained in reaction chamber (109), of fluorescent dye-labeled anti-CRP antibody of the first type and immobilized anti-CRP antibody of second type, between which the CRP is enclosed, is detected by fluorometry. The fluorescent dye is excited, for example, by light having the wavelength of 555 nm. The fluorescent light has, for example, the wavelength of 574 um. The intensity of the fluorescent light is proportional to the amount of CRF present in the provided sample liquid.

### EXAMPLE 6

### Platform with a Plurality of Metering Branches for the Liquid to be Manipulated and a Plurality of Cavities

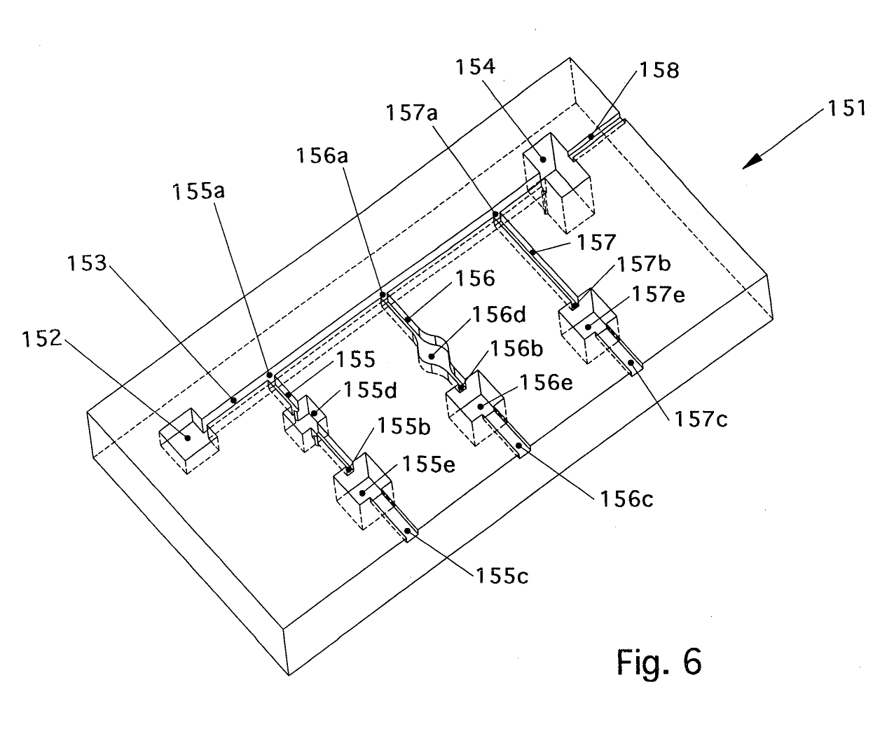

FIG. 6 shows in oblique view a section (151) of a platform with microstructured elements for metering and separating an amount of liquid and with a plurality of cavities. The platform is covered over its entire area. The cover is not shown.

The first capillary (153), which extends to outlet chamber (154), begins at inlet chamber (152). For example, three second capillaries (155, 156, 157) branch off from the first capillary (153). The cross section of each second capillary is smaller at its beginning (155a, 156a, 157a) than the cross section of the first capillary in the area of the branching point. Each second capillary extends to its end (155b, 156b, 157b), at which there is a capillary jump, which acts as a capillary stop. A cavity (155e, 156e, 157e) joints to each capillary stop in each case and is provided for taking up the metered amount of liquid in each case, as soon as the metered amount of liquid stopped at the capillary stop has been caused to overcome the capillary stop. The means necessary for this are not shown in FIG. 6.

There is a widened area (155d) and (156d) in each case between the start and end of the two second capillaries (155) and (156). The volume of each second capillary between its start at the branching point from the first capillary and the capillary stop in the second capillary determines the aliquot of liquid to be metered and separated.

The widened area (155d) of the second capillary (155) is designed as a box-shaped cavity, which is deeper than the second capillary (155) at its entry into said cavity. The two walls of the cavity (155d), in which the capillary (155) enters said cavity and leaves said cavity, are each made as a capillary jump and each provided with a wedge-shaped notch, which extends from the bottom of the capillary to the bottom of the cavity. The action of these two wedge-shaped notches is described further below.

The widened area (156d) of the second capillary (156) is made as a lateral convexity of the second capillary. The bottom of this convexity (156d) transitions smoothly into the bottom of the entering and leaving capillary (156).

The cavity (154) at the end of the first capillary and the cavities (155e, 156e, 157e), which join to the end of each second capillary, are ventilated via the ventilation channels (158, 155e, 156c, 157c) open at their end, as soon as the liquid to be manipulated enters capillary (153), and as soon as the metered aliquots to be separated enter the second capillaries (155, 156, 157).

The second capillary (157) continues without a widened area from its beginning (157a) to its end (157b) in the wall of the capillary jump.

The volumes of the three second capillaries between them start (155a, 156a, 157a) and their end (155b, 156b, 157b) are each different in size. The aliquot of the liquid metered with, capillary (155) is the largest, the aliquot of the liquid metered with capillary (156) is in contrast smaller, and the aliquot of the liquid metered with capillary (157) is the smallest.

The wedge-shaped notches present in the two capillary jumps of the cavity (155d) have different actions. The wedge-shaped notch in the capillary jump wall, in which the capillary enters cavity (155d), enables continuous flowing of the liquid from capillary (155) past the capillary jump into cavity (155d). The wedge-shaped notch in the capillary jump wall, in which the capillary leaves cavity (155d), causes the metered aliquot of the liquid, to flow out the cavity (155) virtually totally into cavity (155e).

A wedge-shaped notch, which effects the virtually total emptying of the capillary (153), is present in the capillary jump wall, in which the capillary (153) discharges into cavity (154).

Before the platform is covered, a predefined amount of different reagents is introduced into each of the cavities (155e, 156e, 157e) and dried. The metered aliquot of the liquid to be manipulated, separated in each branch, reacts in each case with a reagent as soon as the separated metered aliquot has flowed into the cavities (155e, 156e, 157e).

In the platform according to FIG. 6, the liquid to be analyzed is manipulated as follows:

The liquid to be manipulated is introduced into the inlet by means of an injection syringe, with whose cannula the cover in the area of inlet (152) is pierced. The introduced volume of the liquid is somewhat greater than the sum of the three partial volumes, which are separated and metered in the three branches. The microstructure is ventilated via the ends, open to the environment, of ventilation channels (158, 155c, 156c, 157c). The liquid to be manipulated flows by means of capillary force through capillary (153) toward the outlet (154). At each branching point (155a, 156a, 157a), a portion of the liquid enters the capillaries (155, 156, 157) by means of capillary force and fills these to the respective capillary stop (155b, 156b, 157b). The excess of liquid introduced into the inlet flows into outlet (154). As soon as all of the liquid introduced into the inlet has left the inlet, the end of the liquid stream passes sequentially the start of the capillaries (155, 156, 157). In so doing, the metered aliquot contained in each of the capillaries is separated from the rest of the liquid.

The end of the ventilation channel (158) is closed. The cannula of the employed, air-filled syringe is introduced during the piercing into the cover of the platform in the area of the inlet, and the air is injected abruptly into the inlet. The burst of pressure forces the metered amounts of liquid, present in each branch, to overcome the respective capillary stop. The metered aliquots flow into the specifically allocated cavities (155e, 156e, 157e).

In the cavities, in each case a reaction proceeds between the metered, separated aliquot of the liquid to be manipulated and the provided reagent in the predefined amount in each cavity. The reactions proceed parallel to one another and virtually simultaneously.

After the reactions end, the changes, which have or have not occurred in each cavity, are evaluated visually or by photometry. The cavities (155e, 156e, 157e) are the reaction chambers and the analysis chambers.

The microstructured elements present in the platform of the invention will be explained further with use of the following figures. The platform can have capillaries and cavities open at the top, or the capillaries and cavities can be largely covered with a cover. This cover is not shown in the figures.

FIG. 7 shows a section (201) of the platform in oblique view from above. The narrower capillary (202) with a relatively small cross section transitions at the capillary jump (203) into the widened capillary (204) with a relatively large cross section. In the narrower capillary (202), the liquid flows in direction (a) and in the widened capillary (204) in direction (b). A liquid with a sufficiently high surface tension cannot overcome the capillary stop (203) and is stopped there, to wit, also when in a covered platform these two sections transition smoothly into one another on the bottom side of the cover in the area of capillary sections (202) and (203). The liquid stopped in the narrower capillary at capillary stop (203) can be caused to overcome the capillary stop, for example, by ;means of a pressure burst.

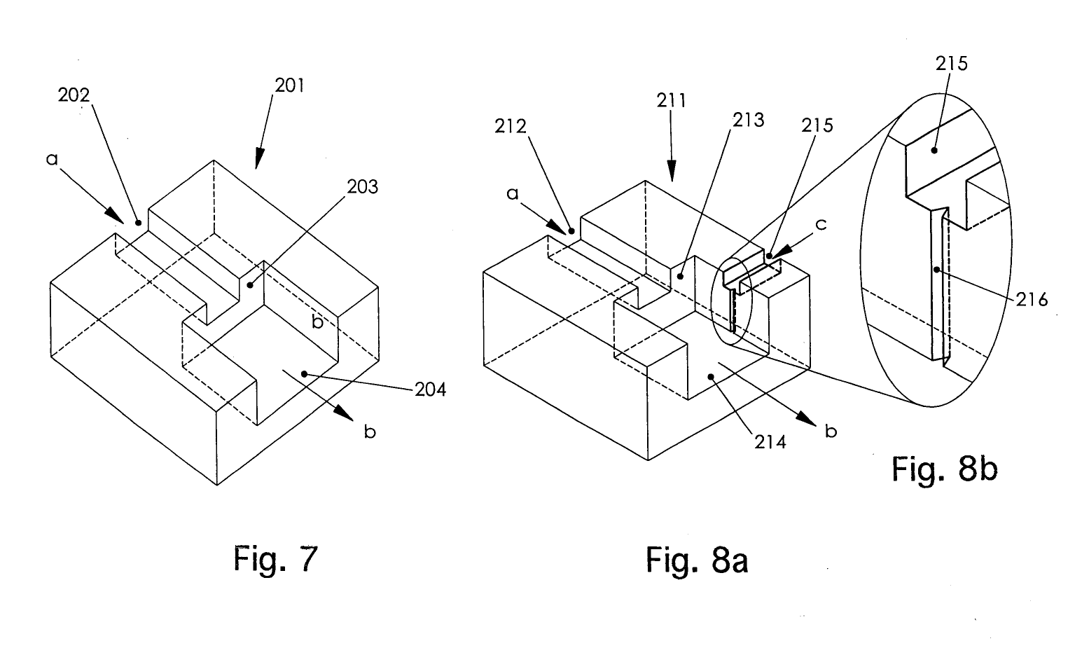

FIG. 8a shows in oblique view from above a section (211) of a platform with a narrower capillary (212), which transitions into the widened capillary (214) at the capillary jump (213). The control capillary (215) ends in a side wall of the widened capillary. At the end of the control capillary (215), in the wall, of the widened capillary (214), there is a wedge-shaped cutout (216), which extends from the bottom of the widened capillary (214) to bottom of the control capillary. The control liquid flows in direction (c) in the control capillary. As soon as the control liquid has reached the wedge-shaped cutout (216), it flows by means of capillary force through the wedge-shaped cutout into the widened capillary (214) and first fills the widened capillary only in the area of capillary jump (213). The end of control capillary (215) does not act as a capillary stop because of the wedge-shaped cutout (216). When a sufficient amount of control liquid has flowed into the widened capillary from control capillary (215), the control liquid comes into contact with the liquid stopped by capillary stop (213) in the narrower capillary (212). By this means, the liquid stopped at the end of the narrower capillary overcomes capillary stop (213) and begins to flow into the widened capillary by capillary force. The arrangement shown in FIG. 8a of fluidic elements has the function of a fluidic switch.

FIG. 8b shows in oblique view from above the end of the control capillary (215) and the wedge-shaped cutout (216) in an enlarged diagram.

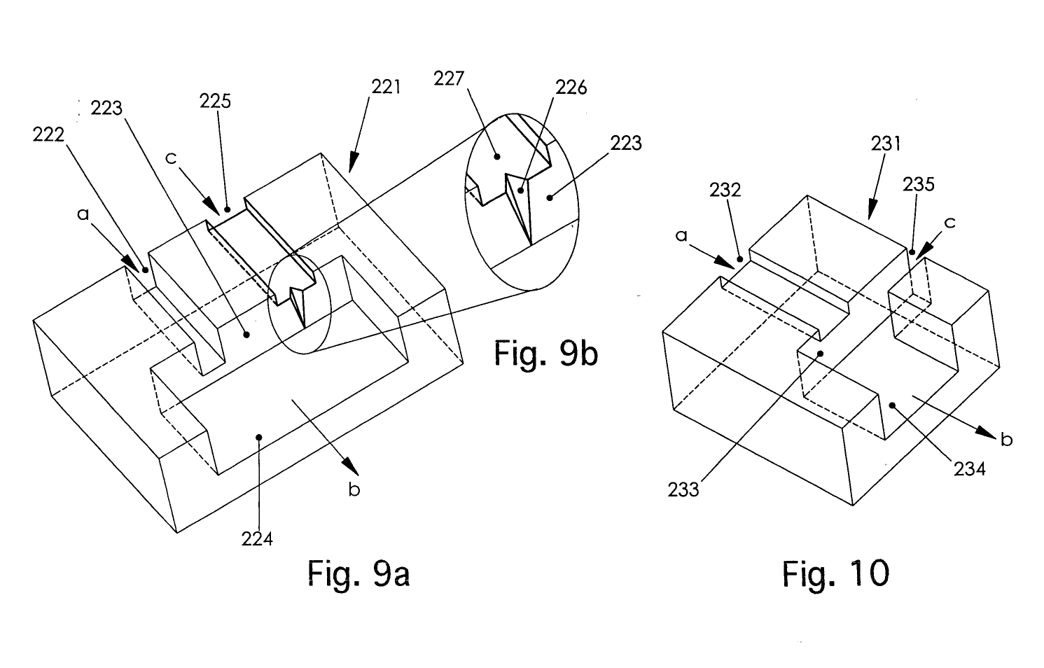

A section (221) of another embodiment of the platform is shown in oblique view from above in FIG. 9a. In the narrower capillary (222), the liquid flows in direction (a) to capillary jump (223), which acts as a capillary stop. The control capillary (225) ends in the wall forming the capillary jump. The wedge-shaped cutout (226) is made at the end of the control capillary; it begins at the end of the bottom of the control capillary and ends approximately at the bottom of the widened capillary. In contrast to cutout (216) in FIG. 8b, cutout (226) is inclined toward the wall forming the capillary jump. The wedge-shaped cutout (226) acts exactly as the wedge-shaped cutout (216) in FIG. 8b.

FIG. 9b shows it oblique view from above the end of control capillary (225) and the wedge-shaped cutout (226) in an enlarged diagram.

In the narrower capillary (222), the liquid to be manipulated flows in direction (a). The control liquid in control capillary (225) flows in direction (c). Both liquids leave the widened capillary (224) in direction (b).

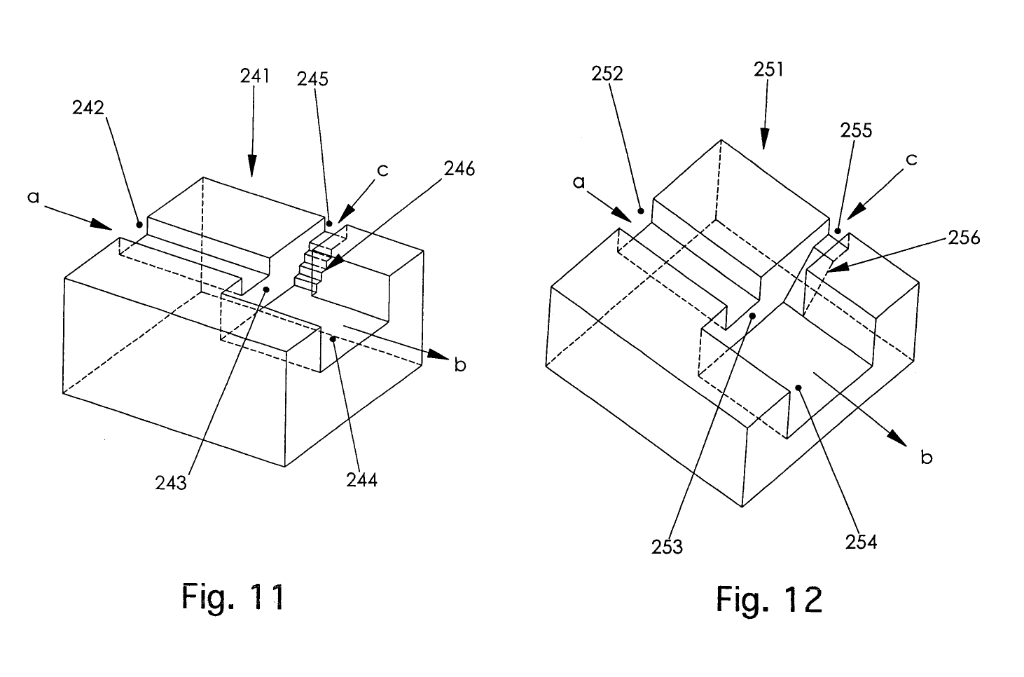

FIG. 10 shows a section (231) of another embodiment of the platform in an oblique view from above. In the narrower capillary (232), the liquid flows in direction (a) up to capillary jump (233), which acts as a capillary stop. The control capillary (235) enters the widened capillary (234) laterally. The control capillary (235) is precisely as deep as the widened capillary (234). In this embodiment, a side wall of the control capillary (235) transitions smoothly into the wall forming the capillary jump. The bottom of the control capillary (235) transitions smoothly into the bottom of the widened capillary. If the platform in the area of the capillary jump is covered, the end of control capillary (235) with a rectangular cross section transitions smoothly on three sides into the widened capillary. This embodiment of the control capillary has the same effect as the control capillaries, shown in FIGS. 8a,b and 9a,b.

FIG. 11 shows a section (241) of another embodiment of the platform in an oblique view froze, above. In the narrower capillary (242), the liquid flows in direction (a) initially up to capillary jump (243), at which it is stopped. In the widened capillary (244), the liquid flows in direction (b). The end region of control capillary (245) is made as stairs (246). The embodiment shown in FIG. 11 of the control capillary has the same effect as the control capillary, shown in FIGS. 8a,b, 9a,b, and 10.

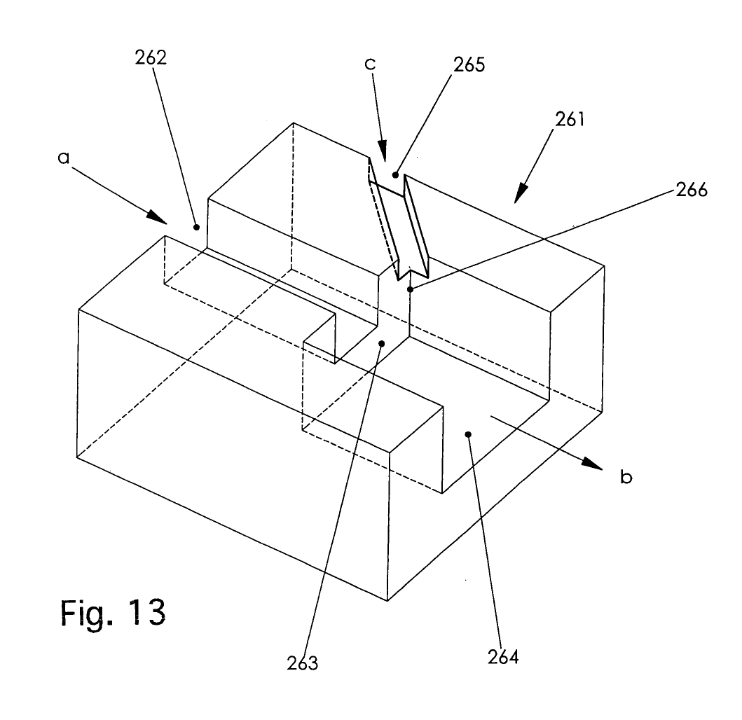

FIG. 12 shows a section (251) of another embodiment of the platform in an oblique view from above. In the narrower capillary (252), the liquid flows in direction (a) first up to capillary jump (253), at which it is stopped. In the widened capillary (254), the liquid flows in direction (b). The end region of control capillary (255) is made as a ramp (256). The embodiment shown in FIG. 12 of the control capillary has the same effect as the control capillary, shown in FIGS. 8a,b, 9a,b, 10, and 11.

FIG. 13 shows a section (261) of another embodiment of the platform in an oblique view from above. In the narrower capillary (262), the liquid flows in direction (a) first up to capillary jump (263), at which it is stopped. In the widened capillary (264), the liquid flows in direction (b). The control capillary (265) discharges into the widened capillary (264) in the area of the edge (266), which is formed by the wall of the capillary jump (263) and a side wall of the widened capillary (264). The edge (266) ends approximately in the middle of the bottom end of the control capillary. This embodiment of the control capillary has the same effect as the control capillaries, shown in FIGS. 8a,b, 9a,b, 10, 11, and 12.

All embodiments shown in FIGS. 8 to 13 have the function of a fluidic switch.

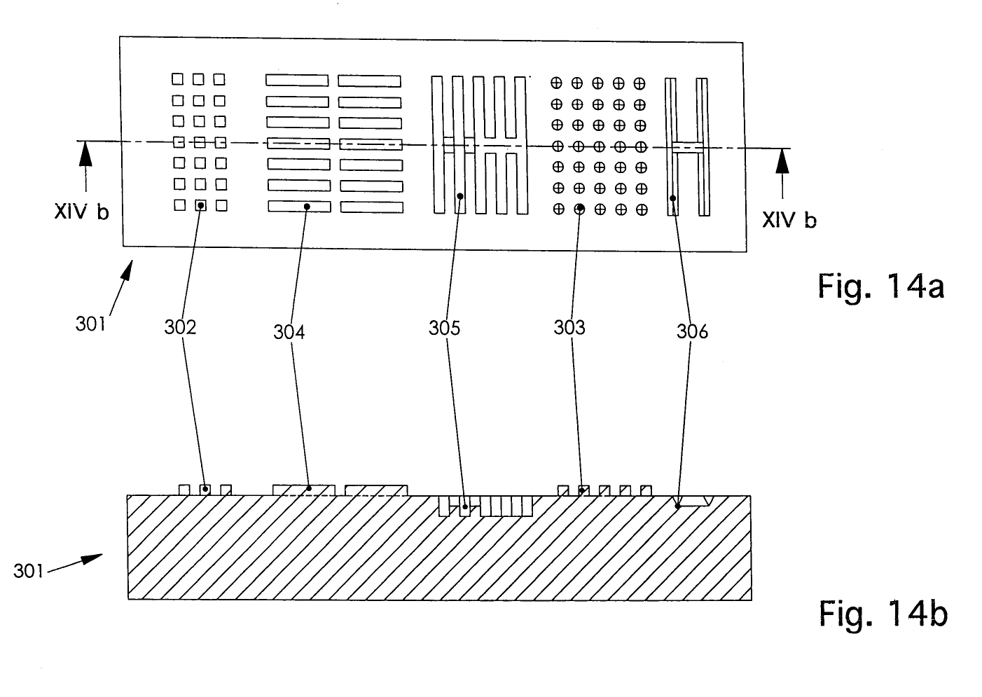

FIG. 14a shows in a top view a section (301) of a platform provided with microstructures in areas. The microstructures serve to hold together a limited amount of liquid.

FIG. 14b shows a cross section through the microstructured region along be XIY b-XIV b in ft 14a.

In a rectangular first region, there are several rows of columns (302) with a rectangular cross section. In a rectangular second region, there are several rows of columns (303) with a round cross section. In a rectangular third region, there are several crosspieces (304) parallel to each other. In a fourth region, there are grooves (305) with a rectangular cross section. Triangular grooves (306) are made in a fifth region. The grooves can differ in depth.

The intervals between the columns or crosspieces are in the millimeter range or less. The width and depth of the grooves is the millimeter range or less. The capillary cavities between the columns or crosspieces and the capillary grooves form a continuous area in each case.

All five regions provided with microstructures are each suitable for holding together a limited amount of a liquid.

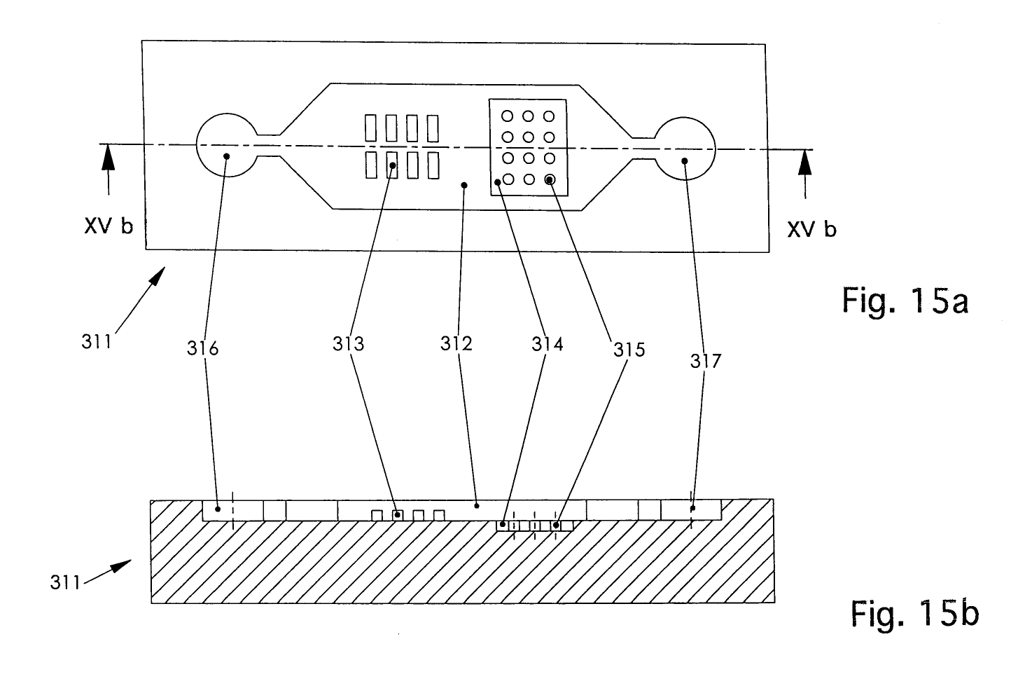

FIG. 15a shows in a top view another embodiment (311) of a platform provided with microstructures for holding together a limited amount of liquid.

FIG. 15b shows a cross section through the microstructured regions along line XVb-XVb in FIG. 15a.

The platform is provided with a cutout (312). In the cutout, there are several rectangular crosspieces (313) in a first region. In a second region, there are several rows of round columns (315) in a recess (314) within the cutout. The cutout comprises further two cavities (316) and (317), which are used to fill the liquid to be manipulated or to collect the liquid that flows away over the microstructured regions.

The distances between the columns or crosspieces are in the millimeter range or less. The capillary cavities between the columns or crosspieces form a continuous area in each case.

Both regions provided with microstructures in the embodiment (311) are each suitable for holding together a limited amount of a liquid. Reagents present in the limited amount of a liquid can each be dried in the regions, in which the limited amount of the liquid is applied and held together.

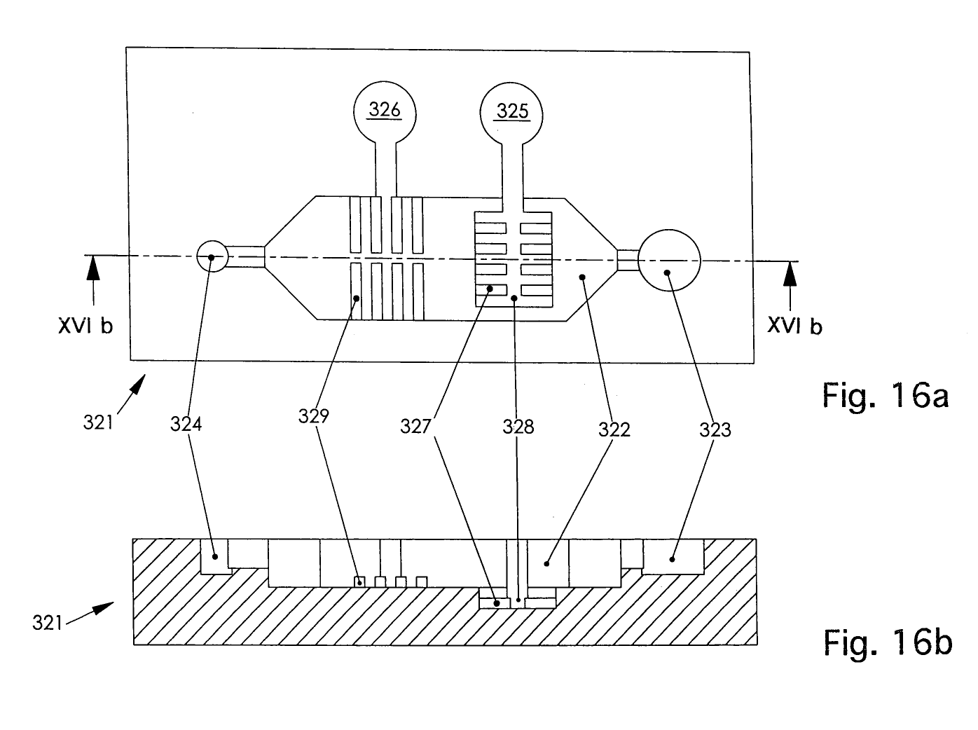

FIG. 16a shows in a top view another embodiment (321) of a covered platform provided with microstructures for holding together a limited amount of liquid.

FIG. 16b shows a cross section through the microstructured regions along line XVI b-XVI b in FIG. 16a.

The platform in FIG. 16a and FIG. 16b is provided with a transparent cover, which is not shown. This cover is attached to the platform before the limited amount of a liquid is applied in the region intended therefor.

The platform is provided in one region with a flat cutout (322), which comprises the cavities (323), (324), (325), and (326). In a first region within the cutout, there is a recess (328), in which crosspieces (327) are present whose height is less than the depth of the recess.

In a second region within the cutout, crosspieces (329), whose height is less than the depth of the cutout, are present on the bottom. The continuous area between the crosspieces (327) is connected with cavity (325). The continuous area between crosspieces (329) is connected with cavity (326).

The cover contains four openings, which lie over the four cavities (323, 324, 325, 326).

Both continuous areas provided with microstructures are each suitable for holding together a limited amount of a liquid. These two regions are accessible individually via the openings in the cover and the cavities (325) and (326) lying thereunder for a liquid, which is to flow only in the continuous areas between the crosspieces (327) and/or (329). Reagents can be present in each case in these two liquids. The limited amounts of liquid applied to these areas can be maintained in liquid form and separate from one another, or they can be dried and be present separate from one another.

The liquid to be manipulated can be tilled into cavity (323) through, the cover opening via cavity (323). It flows by capillary force into cutout (322), reacts first with the reagents, located between the crosspieces (327), and then with the reagents, located between the crosspieces (329). The air displaced from the cutout (322) by the filled liquid escapes via cavity (324) and the overlying opening in the cover. As soon as the liquid to be manipulated has filled the cutout (322) and has arrived in cavity (324), the flow is stopped by the capillary stop at the outer side of the opening in the cover.

The change that has or has not occurred in a property of the liquid to be manipulated after its reaction with the reagents, present between the crosspieces, can be observed visually or by photometry in the area lying downstream from the crosspieces (329).

1. A method for manipulating a first liquid within a device comprising fabricated microstructures for transporting the first liquid through a system of capillary channels and cavities with a closed configuration, the method comprising:
transporting the first liquid through the system by capillary force only;
stopping a flow of the first liquid temporarily at a capillary stop;
switching on the flow of the first liquid after a desired stop time is elapsed by intruding/introducing a second control liquid through a control capillary into a widened portion of the capillary stop;
adjusting the stop time of the first liquid by a length and a cross-section of the control capillary between a beginning of the control capillary and its end at the capillary stop;
metering the first liquid to be manipulated; and
holding a metered amount of the first liquid during the stop time within a cavity.

2. The method of claim 1, further comprising:
separating the first liquid from a dispersion substream laterally to a channel with a capillary gap.

3. The method of claim 1, further comprising:
drawing off a part of the first liquid and transporting the drawn off part of the first liquid through the control capillary to the widened portion of the capillary stop to switch on the flow of the first liquid.

4. The method of claim 1, further comprising:
drawing off the second control liquid from a separate cavity within the device.

5. The method of claim 1, further comprising:
analyzing the first liquid within an analysis chamber disposed within the device.

6. The method claim 1, further comprising:
adding a reagent to the first liquid before analysis, said reagent being disposed within a reaction chamber within the device.

7. The method of claim 1, further comprising:
transporting the first liquid to be manipulated through a plurality of cavities being disposed behind one another.

8. The method of claim 1, further comprising:
transporting the first liquid to be manipulated simultaneously through a plurality of transport paths being disposed parallel to each other, each path comprising capillaries and cavities.

9. The method of claim 1, further comprising:
transporting the first liquid through a branched transport path comprising capillaries and cavities.

10. The method of claim 1, further comprising:
treating a substream of the first liquid by dispersed particles within a cavity of the device.

11. The method of claim 1, further comprising:
transporting the first liquid from an inlet via a first capillary to a first cavity, then through a further capillary to a fluidic switch, then through another further capillary to a second cavity.

12. A device for executing the method of claim 1, comprising:
a fluidic switch comprising a narrow section and a widened section of a capillary as well as a control capillary for feeding a control liquid into the widened section of the capillary after a stop time is elapsed.

13. Application of the device according to claim 12, said device further comprising at least a first capillary and a second capillary with a narrow section and a widened section thus forming a capillary stop, and a control capillary, which is connected to the widened section of the second capillary, said application comprising:
application of said device as a fluidic switch for switching on a flow of the first liquid which has been stopped by the capillary stop, by introducing the control fluid through the control capillary into the widened section of the first capillary after a desired stop time is elapsed.
